(19) United States
(12) Patent Application Publication
(10) Pub. No.: US 2022/0248599 A1
(43) Pub. Date: Aug. 11, 2022

(54) LAWN MOWER ROBOT AND METHOD FOR CONTROLLING THE SAME

(71) Applicant: LG ELECTRONICS INC., Seoul (KR)

(72) Inventors: Hyungkook JOO, Seoul (KR); Seungin SHIN, Seoul (KR); Jaehoon LEE, Seoul (KR)

(73) Assignee: LG ELECTRONICS INC., Seoul (KR)

(21) Appl. No.: 17/626,105

(22) PCT Filed: Nov. 29, 2019
(86) PCT No.: PCT/KR2019/016710

§ 371 Date: Jan. 10, 2022

(30) Foreign Application Priority Data
Jul. 10, 2019 (KR) 10-2019-0083395

(51) Int. Cl. A01D 34/00

(52) U.S. Cl. CPC A01D 34/008

(57) ABSTRACT

A lawn mower robot and a method for controlling the same are disclosed. A lawn mower robot according to an embodiment includes an image sensor module to detect image information. Incline part information related to presence or absence of the incline part and inclination information as information related to a shape of the incline part are calculated based on the detected image information. The lawn mower robot is controlled to operate according to operation information calculated based on the incline part information and the inclination information, so as to perform a task efficiently.

### CROSS-REFERENCE TO RELATED APPLICATIONS

This application is the National Stage filing under 35 U.S.C. 371 of International Application No. PCT/KR2019/016710, filed on Nov. 29, 2019, which claims the benefit of earlier filing date and right of priority to Korean Application No. 10-2019-0083395, filed on Jul. 10, 2019, the contents of which are all hereby incorporated by reference herein in their entirety.

### TECHNICAL FIELD

This application relates to a lawn mower robot and a method for controlling the same, and one particular implementation relates to a lawn mower robot having a structure capable of preventing wheel slippage by avoiding an incline part (inclined surface, inclined portion, or incline) when the incline part is present, and a method for controlling the same.

### BACKGROUND ART

A lawn mower robot is a machine for mowing grass or lawn by moving itself according to preset control information. A user may input in advance control information related to desired mowing motion, time, and period. The lawn mower robot operates according to the input control information.

The lawn mower robot may perform a task while moving along a preset path in a specific area. In order to determine whether the lawn mower robot is moved along the path, the lawn mower robot may be provided with an encoder sensor.

The encoder sensor may detect turns of wheels of the lawn mower robot, a wheel turn time, and the like. Using the detected wheel turns and wheel turn time, a distance traveled by the lawn mower robot may be computed.

By the way, it is common for the lawn mower robot to perform its work outdoors, such as a garden or a grassy place. Thus, while the lawn mower robot is performing its work, an unexpected situation may occur. For example, there may exist an incline part (or inclined part) which makes travel of the lawn mower robot difficult.

When the lawn mower robot travels along the incline part, wheel slippage that wheels slip or spin free may occur. In this case, even if the lawn mower robot does not move, the wheel may be in a state of being kept turning.

As a result, errors may occur in the detection result of the encoder sensor and the calculated movement distance. As a result, it is unclear to determine whether the lawn mower robot has been correctly moved along a preset path.

Accordingly, reliability of the work of the lawn mower robot may be lowered. Convenience and satisfaction of a user of the lawn mower robot may also be lowered.

Korean Registration Patent Application No. 10-1526334 discloses a lawn mower robot. Specifically, the application mentioned above discloses a lawn mower robot having an angle adjustment actuator, which is capable of adjusting angles of front and rear frames forming a body.

The prior art document discloses an effect of stably climbing up an inclined portion by adjusting angles of the front and rear frames when the inclined portion is present on a path along which the robot is traveling.

However, since the lawn mower robot having such a configuration needs an additional structure for adjusting the angles of the front and rear frames, the configuration of the lawn mower robot is made complicated. In addition, the front and rear frames may travel along an incline part. However, there is no consideration about a method for preventing wheel slippage, which may occur as the robot enters the incline part.

Korean Registration Patent Application No. 10-0189345 discloses a continuous autonomous grass cutter. In detail, the prior art document discloses a grass cutter capable of detecting an incline part using battery resistance calculated by comparing an amount of energy supplied to a driving wheel and a speed of the wheel, and avoiding the detected incline part.

However, this type of grass cutter provides a way to avoid the incline part, but fails to consider a way to maintain grass growing on the incline part. That is, since the grass growing on the incline part is not maintained or cared, there is a limit that it is difficult to completely perform a work on an area desired by a user.

### BACKGROUND ART DOCUMENTS

Korean Registration Patent Application No. 10-1526334 (Jun. 9, 2015)
Korean Registration Patent Application No. 10-0189345 (Dec. 27, 2001)

### SUMMARY

### Technical Problem

The present disclosure provides a lawn mower robot having a structure capable of solving those drawbacks, and a method for controlling the same.

First, one aspect of the present disclosure is to provide a lawn mower robot having a structure, capable of effectively detecting whether an incline part exists in an environment in which the lawn mower robot is traveling, and a method for controlling the same.

Another aspect of the present disclosure is to provide a lawn mower robot having a structure, capable of more accurately detecting whether or not an incline part exists, and a method for controlling the same.

Still another aspect of the present disclosure is to provide a lawn mower robot having a structure, capable of effectively detecting detailed information related to an incline part when the incline part exists, and a method for controlling the same.

Still another aspect of the present disclosure is to provide a lawn mower robot having a structure, capable of effectively changing a travel path when an incline part exists, and a method for controlling the same.

Still another aspect of the present disclosure is to provide a lawn mower robot having a structure, capable of effectively maintaining or caring lawn growing on an incline part when the incline part exists, and a method for controlling the same.

Still another aspect of the present disclosure is to provide a lawn mower robot having a structure, capable of preventing wheel slippage of the lawn mower robot, which has entered an incline part, when the incline part is present, and a method for controlling the same.

Still another aspect of the present disclosure is to provide a lawn mower robot having a structure, capable of effectively performing a lawn mowing (caring) task even if an incline part exists in a designated area, and a method for controlling the same.

### Solution to Problem

In order to achieve the above aspect, there is provided a lawn mower robot, including a body part rotatably coupled to a main wheel, a power module rotated according to operation information so as to rotate the main wheel, a sensor part provided on the body part to detect external image information related to one side of the body part, and a controller to calculate the operation information, electrically connected to the power module to transfer the calculated operation information, and electrically connected to the sensor part to receive the detected image information. The controller may calculate the operation information using the detected image information.

The controller may calculate incline part information related to whether or not an incline part is present on a ground of the one side, using the detected image information.

The controller may calculate inclination information related to the incline part using the detected image information, and the inclination information may include angle information related an angle between a surface of the incline part and the ground, and extension distance information related to a distance by which the surface of the incline part extends.

The controller may calculate the operation information using the calculated incline part information and inclination information.

The main wheel of the lawn mower robot may include a first main wheel located on one side of the body part, and a second main wheel located on another side of the body part, opposite to the first main wheel. The power module may include a first power module connected to the first main wheel, and a second power module connected to the second main wheel. The operation information may include first steering information for controlling a rotational speed of the first power module, and second steering information for controlling a rotational speed of the second power module.

The controller may calculate the first steering information and the second steering information, so that the rotational speed of the first power module and the rotational speed of the second power module alternately change in magnitude.

The sensor part of the lawn mower robot may be configured to detect tilt information related to an angle between the body part and the ground, and the controller may calculate the incline part information and the inclination information using the detected tilt information.

The sensor part of the lawn mower robot may be configured to detect rotation information related to turns of the main wheel, and the controller may calculate the incline part information and the inclination information using the detected rotation information.

In addition, the sensor part may be configured to detect position information related to a position of the body part, and the controller may calculate the incline part information and the inclination information using the detected position information.

The present disclosure also provides a method for controlling a lawn mower robot, which may include (a) detecting, by a sensor part, information related to an operating state of the lawn mower robot, (b) calculating, by an incline part information calculation module, information related to an external environment of the lawn mower robot using the detected information, (c) calculating, by an operation information calculation module, operation information using the calculated information related to the external environment, and (d) controlling a power module according to the calculated operation information.

The step (a) of the method may include (a1) sensing, by an image sensor module, external image information related to one side of a body part of the lawn mower robot, (a2) detecting, by a position sensor module, position information related to a position of the body part, (a3) sensing, by a rotation sensor module, rotation information related to turns of a main wheel rotatably connected to the body part, and (a4) detecting, a tilt sensor module, tilt information related to an angle between the body part and a ground.

Also, the step (b) of the method may include (b1) calculating, by the incline part information calculation module, incline part information related to whether an incline part is present on the ground of the one side by a preset method, using at least one of the detected image information, position information, rotation information, and tilt information, (b2) comparing, by the incline part information calculation module, the calculated incline part information with preset reference incline part information, and (b3) calculating, by the incline part information calculation module, inclination information related to inclination of the incline part by a preset method using at least one of the detected image information, position information, rotation information, and tilt information, when a result of the comparison corresponds to a preset condition. The preset condition may correspond to presence of the incline part on the ground of the one side.

The step (c) of the method may include (c1) calculating, by a driving information calculation unit, driving information by a preset method using at least one of the calculated incline part information and inclination information, and (c2) calculating, by a steering information calculation unit, steering information by a preset method using at least one of the calculated incline part information and inclination information.

The main wheel of the lawn mower robot may include a first main wheel located on one side of the body part, and a second main wheel located on another side of the body part, opposite to the first main wheel. The power module may include a first power module connected to the first main wheel, and a second power module connected to the second main wheel. The steering information calculated in the step (c1) of the control method may be calculated so that a rotational speed of the first power module and a rotational speed of the second power module alternately change in magnitude.

The step (d) of the method may include (d1) rotating, by a power module control unit, the power module according to the calculated steering information, and (d2) rotating, by the power module control unit, the power module according to the calculated driving information.

The method may further include after the step (d), (e) operating the power module according to preset operation information.

The step (e) of the method may include (e1) detecting, by the image sensor module, the external image information related to the one side of the body part of the lawn mower robot, (e2) calculating, by the incline part information calculation module, the incline part information by a preset method using the detected image information, (e3) comparing, by the incline part information calculation module, the incline part information with reference incline part information, and (e4) controlling, by the power module control unit, the power module according to preset operation information when a result of the comparison does not correspond to the preset condition.

The step (e) of the method may include, after the step (e3), (e5) calculating, by the incline part information calculation module, inclination information using the image information detected by the incline part information calculation module, when the result of the comparison corresponds to the preset condition, (e6) calculating, by the driving information calculation unit, driving information by using at least one of the calculated incline part information and inclination information, (e7) calculating, by the steering information calculation unit, steering information using at least one of the detected incline part information and inclination information, and (e8) controlling, by the power module control unit, the power module according to the calculated driving information and steering information.

### Advantageous Effects

According to the present disclosure, the following effects can be achieved. First, an image sensor module is configured to detect image information in a direction in which a lawn mower robot proceeds. A controller can determine whether or not an incline part (or inclined surface) exists on a travel path of the lawn mower robot by calculating incline part information using the image information.

Therefore, presence or absence of an incline part can be determined in advance even if the lawn mower robot does not enter the incline part.

In addition, a sensor part includes various sensor modules. The respective sensor modules may detect distance information, position information, rotation information, tilt information, and the like. The controller may calculate presence or absence of an incline part using those pieces of information.

Therefore, presence or absence of an incline part can be calculated based on various pieces of information. This may result in more accurately detecting the presence or absence of the incline part.

In addition, the various sensor modules included in the sensor part can detect distance information, position information, rotation information, tilt information, and the like. The controller can calculate detailed information on the incline part using those pieces of information.

Therefore, information related to an incline part can be calculated based on various pieces of information. This may enable calculation and recognition of detailed information related to an incline part which is present.

In addition, an operation information calculation module is configured to calculate operation information using calculated information related to an incline part.

Therefore, when an incline part is present, the lawn mower robot can perform a task for maintaining grass efficiently and effectively by effectively changing its travel path.

In addition, when an incline part exists, operation information suitable for the lawn mower robot to travel on the incline part is calculated. The lawn mower robot is controlled to move zigzag to the left and right of a traveling direction according to the operation information.

Therefore, grass that lives on the incline part can also be maintained (managed) effectively.

Furthermore, the lawn mower robot operates on an incline part according to operation information suitable for operating on the incline part.

Therefore, since the lawn mower robot is controlled according to operation information suitable for an incline part that the robot has entered, slippage of a main wheel can be prevented.

In addition, as described above, the lawn mower robot can effectively maintain grass that lives on an incline part. This may result in performing a lawn mowing task, without any exceptional region from an area where the task is performed.

### BRIEF DESCRIPTION OF DRAWINGS

FIG. 1 is a perspective view illustrating appearance of a lawn mower robot in accordance with an embodiment.

FIG. 2 is a lateral view illustrating appearance of one side of the lawn mower robot of FIG. 1.

FIG. 3 is a block diagram illustrating a configuration of the lawn mower robot of FIG. 1.

FIG. 4 is a flowchart illustrating a method for controlling a lawn mower robot in accordance with an embodiment.

FIG. 5 is a flowchart illustrating a detailed flow of a step S100 of FIG. 4.

FIG. 6 is a flowchart illustrating a detailed flow of a step S200 of FIG. 4.

FIG. 7 is a flowchart illustrating a detailed flow of a step S300 of FIG. 4.

FIG. 8 is a flowchart illustrating a detailed flow of a step S400 of FIG. 4.

FIG. 9 is a flowchart illustrating a detailed flow of a step S500 of FIG. 4.

FIG. 10 is a planar view illustrating a traveling process of the lawn mower robot of FIG. 1.

FIG. 11 is a lateral view illustrating a traveling process of the lawn mower robot of FIG. 1.

FIG. 12 is a lateral view illustrating a traveling process of the lawn mower robot of FIG. 1.

FIG. 13 is a partially enlarged lateral view of the lawn mower robot traveling in an area A of FIG. 12.

FIG. 14 is a partially enlarged lateral view of the lawn mower robot traveling in the area A of FIG. 12.

FIG. 15 is a partially enlarged lateral view of the lawn mower robot traveling in the area A of FIG. 12.

FIG. 16 is a partially enlarged lateral view of the lawn mower robot traveling in the area A of FIG. 12.

FIG. 17 is a planar view illustrating one example in which the lawn mower robot of FIG. 1 proceeds in the situations of FIGS. 13 to 16.

FIG. 18 is a planar view illustrating another example in which the lawn mower robot of FIG. 1 proceeds in the situations of FIGS. 13 to 16.

### DETAILED DESCRIPTION

Hereinafter, a lawn mower robot and a method for controlling the same according to embodiments will be described in detail, with reference to the accompanying drawings.

In the following description, description of some components may be omitted in order to clarify the technical characteristics of this disclosure.

### 1. Definition of Terms

The term “lawn” or “grass” as used in the following description means any plant that is growing on a specific area and can be mowed or cut by a lawn mower robot 10.

As used in the following description, the term “work” or “task” means a series of operations performed by the lawn mower robot 10 to mow and maintain lawn, grass and the like in a specific area.

The term “advancing”, “moving forward” or “proceeding” as used in the following description means an operation in which the lawn mower robot 10 moves in a specific direction to perform a task.

As used in the following description, the term “moving backward” or “reversing” means an operation in which the lawn mower robot 10 moves in a direction opposite to a specific direction in which the lawn mower robot 10 moves to perform a task.

As used in the following description, the term “electrically connected” means that one component and another component are electrically connected to each other or connected to perform information communication. The electric connection may be realized by a conductor wire, a communication cable, and the like.

As used in the following description, the term “incline part”, “inclined portion”, or “incline” means a protruded landform (terrain, topology) which protrudes from a flat ground surface or a horizontal surface or extends at a predetermined angle with the flat ground surface or the horizontal surface.

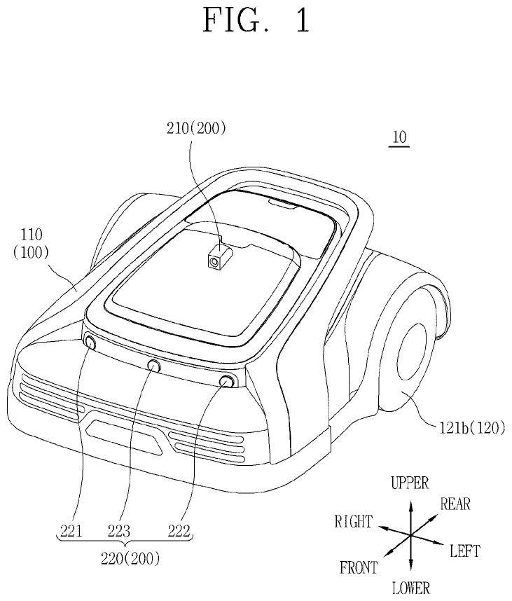

The terms “front side”, “rear side”, “upper side”, “lower side”, “right side”, and “left side” used in the following description will be understood with reference to a coordinate system shown in FIG. 1.

### 2. Description of Configuration of Lawn Mower Robot 10 According to Embodiment

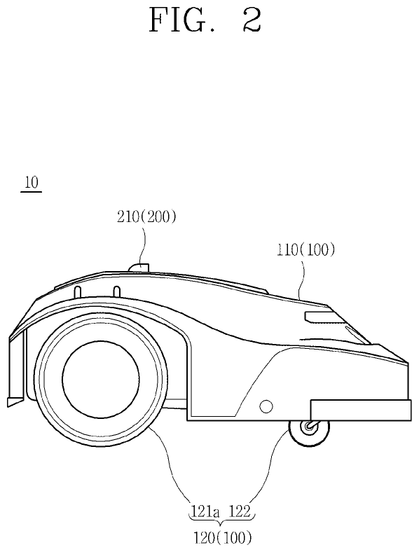

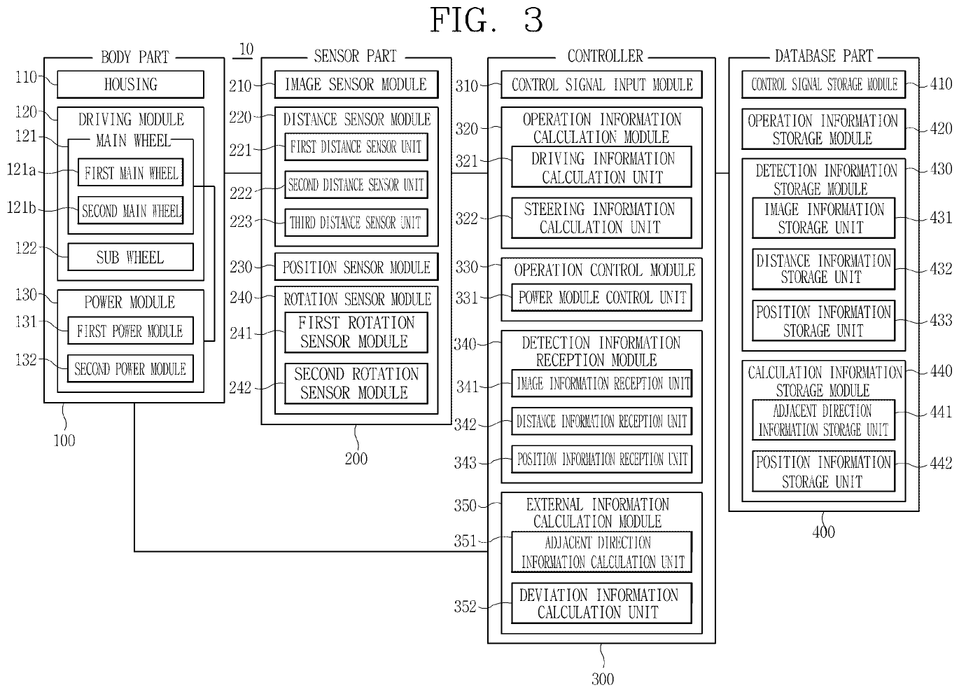

Referring to FIGS. 1 to 3, a lawn mower robot 10 according to an embodiment disclosed herein includes a body part 100, a sensor part 200, a controller 300, and a database part 400.

(1) Description of Body Part 100

The body part 100 defines a body of the lawn mower robot 10. The body part 100 includes a housing 110, a driving module 120, and a power module 130.

The housing 110 defines an outer side of the body part 100.

The housing 110 is preferably formed of a lightweight and highly durable material. In one embodiment, the housing 110 may be formed of a synthetic resin such as reinforced plastic or the like.

The sensor part 200 may be partially provided on an outer side of the housing 110. In addition, although not indicated by a reference numeral, a handle easily gripped by a user may be provided on the outer side of the housing 110.

A predetermined space is formed inside the housing 110. In the space, the part of the sensor part 200, the controller 300, and the database part 400 may be disposed.

Openings are formed at both sides of the housing 110, namely, at both right and left sides in the illustrated embodiment. A main wheel 121 is located in the openings.

An image sensor module 210 of the sensor part 200 is located on one side of the housing 110, namely, on a top of the housing 110 in the illustrated embodiment.

A sub wheel 122 is located on another side of the housing 110, namely, on a bottom of the housing 110 in the illustrated embodiment. A blade (not shown) is also provided on the bottom of the housing 110 to perform a task for maintaining the lawn.

A distance sensor module 220 of the sensor part 200 is located on another side of the housing 110, namely, on a front side in the illustrated embodiment.

The driving module 120 functions as a component which allows the lawn mower robot 10 to travel. The driving module 120 is connected to the power module 130.

A driving force generated by the power module 130 is transmitted to the driving module 120, so that the lawn mower robot 10 can move to the front or to the rear. In addition, as will be described later, the power module 130 may be provided in plurality and driven independently. Accordingly, the driving module 120 may also be independently driven to change a direction in which the lawn mower robot 10 travels.

The driving module 120 includes a main wheel 121 and a sub wheel 122.

The main wheel 121 is connected to the power module 130 and receives the driving force generated by the power module 130. The main wheel 121 is rotated by the driving force, so that the lawn mower robot 10 can move to the front or rear side.

In the illustrated embodiment, the main wheel 121 is located at the rear side of the housing 110.

The main wheel 121 may be provided in plurality. In the illustrated embodiment, the main wheel 121 includes a first main wheel 121a and a second main wheel 121b.

The first main wheel 121a is located in an opening formed at the right side of the rear of the housing 110. In addition, the second main wheel 121b is located in an opening formed at the left side of the rear of the housing 110.

The first main wheel 121a and the second main wheel 121b are disposed opposite to each other. The first main wheel 121a and the second main wheel 121b may be rotated independently of each other. To this end, the first main wheel 121a and the second main wheel 121b may be connected to a first power module 131 and a second power module 132, respectively.

The main wheel 121 may be formed in an arbitrary shape which is rotated by a rotational force so that the lawn mower robot 10 can move. In one embodiment, the main wheel 121 may be provided in the form of a wheel.

The sub wheel 122 is located on a bottom of the front of the lawn mower robot 10. The sub wheel 122 supports the front side of the lawn mower robot 10.

In the illustrated embodiment, the sub wheel 122 is provided by one in number. Alternatively, the sub wheel 122 may be provided in plurality. In the alternative embodiment, the lawn mower robot 10 may be stably supported by the plurality of sub wheels 122.

The sub wheel 122 may be provided in an arbitrary form to be rotatably coupled to the lawn mower robot 10. In one embodiment, the sub wheel 122 may be provided in the form of a wheel.

When the main wheel 121 is steered, the sub wheel 122 may be rotated in a direction in which the lawn mower robot 10 proceeds.

The power module 130 generates a driving force for the lawn mower robot 10. The power module 130 may be electrically connected to the controller 300 to receive driving information and steering information.

In one embodiment, the power module 130 may be provided as a motor. The power module 130 may be accommodated in an inner space of the housing 110.

The power module 130 may receive power from outside. In one embodiment, the power module 130 may receive power from a battery (not shown) provided in the lawn mower robot 10. The power module 130 may be electrically connected to the battery (not shown).

The driving module 130 is connected to the main wheel 121. When the power module 130 is rotated, the main wheel 121 may also be rotated. Accordingly, the driving force generated by the power module 130 is transmitted to the main wheel 121.

The power module 130 may be provided in plurality. In the illustrated embodiment, the power module 130 includes a first power module 131 and a second power module 132.

The first power module 131 is connected to the first main wheel 121a. When the first power module 131 is rotated, the first main wheel 121a may be rotated. The second power module 132 is connected to the second main wheel 121b. When the second power module 132 is rotated, the second main wheel 121b may be rotated.

Accordingly, the lawn mower robot 10 may move forward or backward by the first power module 131 and the second power module 132.

The first power module 131 and the second power module 132 may be driven independently of each other. That is, whether each of the first power module 131 and the second power module 132 rotates, the number of turns, etc. may be independently controlled. To this end, the first power module 131 and the second power module 132 may be electrically connected to the controller 300, respectively.

As the first power module 131 and the second power module 132 are rotated at different speeds, a direction in which the lawn mower robot 10 proceeds may change.

(2) Description of Sensor Part 200

The sensor part 200 detects information on an external environment in which the lawn mower robot 10 operates. In addition, the sensor part 200 detects information on a driving situation of the lawn mower robot 10. Various pieces of information detected by the sensor part 200 may be transmitted to the controller 300, and the controller 300 may generate control information suitable for situations.

The sensor part 200 may be provided in an arbitrary form, which is capable of detecting information on an external environment or a driving situation of the lawn mower robot 10.

The sensor part 200 may be electrically connected to a battery (not shown). Power required for an operation of the sensor part 200 may be supplied by the connection.

The sensor part 200 includes an image sensor module 210, a distance sensor module 220, a position sensor module 230, a rotation sensor module 240, and a tilt sensor module 250.

The image sensor module 210 is configured to detect external image information related to one side of the lawn mower robot 10. In one embodiment, the image sensor module 210 may be configured to detect image information related to the front side in a direction in which the lawn mower robot 10 is traveling.

Accordingly, obstacles or the like located on an expected path of the lawn mower robot 10 can be detected based on the image information detected by the image sensor module 210.

In particular, in the embodiment disclosed herein, an incline part (or incline) which is located on an expected path of the lawn mower robot 10 may be detected based on image information detected by the image sensor module 210.

The image sensor module 210 may be provided in any form capable of acquiring image information, that is, still images or moving images (videos). In one embodiment, the image sensor module 210 may be implemented as a camera, a camcorder, or the like.

The image sensor module 210 may be electrically connected to a detection information reception module 340 of the controller 300. The image information detected by the image sensor module 210 may be transferred to an image information reception unit 341 and used to calculate operation information.

In the illustrated embodiment, the image sensor module 210 is located on a top of the housing 110. The image sensor module 210 may be disposed at any position where image information can be acquired.

The distance sensor module 220 is configured to detect a distance between the lawn mower robot 10 and an arbitrary object outside the lawn mower robot 10. That is, the distance sensor module 220 is configured to detect spaced distance information which is information on a distance between the lawn mower robot 10 and the object.

The distance sensor module 220 may be provided in any form capable of detecting a distance from an arbitrary object. In one embodiment, the distance sensor module 220 may be configured as an ultrasonic sensor, an infrared ray (IR) sensor, a light detection and ranging (LiDAR) sensor, a radio detecting and ranging (Radar) sensor, a camera (stereo camera), or the like.

The distance sensor module 220 may be electrically connected to the detection information reception module 340 of the controller 300. The spaced distance information detected by the distance sensor module 220 may be transferred to a distance information reception unit 342, and used to calculate operation information.

The distance sensor module 220 is located on the front side of the housing 110.

The distance sensor module 220 may be provided in plurality. In the illustrated embodiment, the distance sensor module 220 includes a first distance sensor unit 221, a second distance sensor unit 222, and a third distance sensor unit 223.

The first distance sensor unit 221 may be configured to detect first spaced distance information that is spaced distance information in a preset first direction. To this end, the first distance sensor unit 221 may be located to be inclined toward the first direction.

In the illustrated embodiment, the first direction indicates a right side, and the first distance sensor unit 221 may be inclined to the right side of the front of the housing 110.

The second distance sensor unit 222 may be configured to detect second spaced distance information which is spaced distance information in a preset second direction. To this end, the second distance sensor unit 222 may be located to be inclined toward the second direction.

In the illustrated embodiment, the second direction indicates a left side, and the second distance sensor unit 222 may be located to be inclined to the left side of the front of the housing 110.

The third distance sensor unit 223 may be configured to detect third spaced distance information which is spaced distance information in a preset third direction. To this end, the third distance sensor unit 223 may be located to face the third direction.

In the illustrated embodiment, the third direction indicates the front side, and the third distance sensor unit 223 may be located to face the front side of the housing 110.

The third direction may be located between the first direction and the second direction. In the illustrated embodiment, the third direction is located to face the front side, namely, between the first direction facing the right side and the second direction facing the left side.

Therefore, the first distance sensor unit 221 detects first spaced distance information from an object located at the right side of the lawn mower robot 10. In addition, the second distance sensor unit 222 detects second spaced distance information from an object located at the left side of the lawn mower robot 10. Furthermore, the third distance sensor unit 223 detects third spaced distance information from an object located at the front side of the lawn mower robot 10.

This takes into account that the lawn mower robot 10 generally travels to the front side and to the right and left sides with respect to the front side. Accordingly, frequency at which the lawn mower robot 10 collides with an object present on a travel path can be reduced, so that an efficient lawn maintenance work can be performed.

The position sensor module 230 is configured to detect position information related to the lawn mower robot 10. That is, the position sensor module 230 may set an area in which the lawn mower robot 10 performs a task in one coordinate system, and detect the position of the lawn mower robot 10 in the form of coordinate information.

The position sensor module 230 may be provided in any form capable of detecting a position of a currently moving object in a predetermined manner. In one embodiment, the position sensor module 230 may be configured as a Global Positioning System (GPS) sensor.

The position sensor module 230 may be accommodated in a predetermined space formed inside the housing 110. Alternatively, the position sensor module 230 may be located outside the housing 110 to improve reception efficiency.

The position sensor module 230 may be electrically connected to the detection information reception module 340 of the controller 300. The position information detected by the position sensor module 230 may be transferred to a position information reception unit 343 and used to calculate operation information.

A rotation sensor module 240 is configured to detect rotation information related to the number of turns of the main wheel 121. The rotation sensor module 240 may be provided in the main wheel 121 or the power module 130. This results from that the main wheel 121 and the power module 130 have the same number of turns or revolutions.

The rotation sensor module 240 may be provided in any form capable of detecting the number of turns or rotations of a rotating object. In one embodiment, the rotation sensor module 240 may be configured as a photo sensor or the like.

The rotation sensor module 240 may be provided in plurality. In the illustrated embodiment, the rotation sensor module 240 is configured by totally two modules, namely, a first rotation sensor module 241 and a second rotation sensor module 242. This is because the main wheel 121 and the power module 130 are provided by two in number, respectively.

The first rotation sensor module 241 is located adjacent to the first main wheel 121a or the first power module 131. The first rotation sensor module 241 may detect the number of rotations or a rotational speed of the first main wheel 121a or the first power module 131.

The second rotation sensor module 242 is located adjacent to the second main wheel 121b or the second power module 132. The second rotation sensor module 242 may detect the number of rotations or a rotational speed of the second main wheel 121b or the second power module 132.

The tilt sensor module 250 is configured to detect tilt information related to the lawn mower robot 10.

That is, the tilt sensor module 250 may detect tilt information related to whether the lawn mower robot 10 maintains a horizontal state. The tilt information may be expressed in the form of an angle formed between the tilt sensor module 250 and a horizontal surface (plane).

The tilt sensor module 250 may be provided in any form capable of detecting a tilt of an arbitrary object in a preset manner. In one embodiment, the tilt sensor module 250 may be configured as a gyroscope sensor.

The tilt sensor module 250 may be accommodated in a predetermined space formed inside the housing 110. The tilt sensor module 250 may be provided at any position where the tilt information on the lawn mower robot 10 can be detected.

The tilt sensor module 250 is electrically connected to the detection information reception module 340 of the controller 300. The tilt information detected by the tilt sensor module 250 may be transferred to a tilt information reception unit 345 and used to calculate operation information.

(3) Description of Controller 300

The controller 300 receives a control signal from a user and calculates operation information for operating the lawn mower robot 10.

In addition, the controller 300 may receive various detection information detected by the sensor part 200. To this end, the controller 300 is electrically connected to the sensor part 200.

The controller 300 may calculate operation information using the received control signal or detection information. In addition, the controller 300 may control each component, specifically, the power module 130 of the lawn mower robot 10 according to the calculated operation information. To this end, the controller 300 is electrically connected to the power module 130.

Also, the controller 300 is electrically connected to the database part 400. A control signal input by a user, detection information detected by the sensor part 200, and various pieces of information calculated by the controller 300 may be stored in the database part 400.

Various modules and units of the controller 300 to be described later may be electrically connected to one another. Accordingly, information input to one module or unit or information calculated by one module or unit may be transferred to another module or unit.

The controller 300 may be provided in any form capable of inputting, outputting, and calculating information. In one embodiment, the controller 300 may be configured as a microprocessor, a central processing unit (CPU), a printed circuit board (PCB), or the like.

The controller 300 is located in a predetermined space formed inside the housing 110. The controller 300 may be hermetically accommodated in the space so as not to be affected by external moisture and the like.

The controller 300 includes a control signal input module 310, an operation information calculation module 320, an operation control module 330, a detection information reception module 340, and an incline part information calculation module 350.

The control signal input module 310 receives a control signal which is input by a user for operating the lawn mower robot 10. The user may input such a control signal through a terminal or the like. In one embodiment, the terminal may be a smartphone or the like.

In another embodiment, the user may input a control signal through an input interface (not shown) included in the lawn mower robot 10. In the above embodiment, the control signal input module 310 may be electrically connected to the input interface (not shown).

The control signal input to the control signal input module 310 is transmitted to the operation information calculation module 320. In addition, the control signal input to the control signal input module 310 may be transmitted to a control signal storage module 410 of the database part 400.

The operation information calculation module 320 calculates operation information for operating the lawn mower robot 10.

The operation information calculation module 320 may calculate operation information by using a control signal input through the control signal input module 310 or each information calculated by the incline part information calculation module 350.

In one embodiment, the operation information may include driving information and steering information. The driving information may be defined as operation information related to forward or backward movement of the lawn mower robot 10. In addition, the steering information may be defined as operation information related to a direction in which the lawn mower robot 10 proceeds to the left or the right.

The operation information calculated by the operation information calculation module 320 is transmitted to the operation control module 330. The operation information calculated by the operation information calculation module 320 is also transmitted to an operation information storage module 420 of the database part 400.

The operation information calculation module 320 includes a driving information calculation unit 321 and a steering information calculation unit 322.

The driving information calculation unit 321 calculates the driving information. The driving information calculation unit 321 may calculate driving information by using a control signal input through the control signal input module 310 or each information calculated by the incline part information calculation module 350.

The driving information calculated by the driving information calculation unit 321 may include information on a rotational direction of the first power module 131 and the second power module 132.

In detail, the first power module 131 and the second power module 132 may be rotated in a preset first rotational direction. In addition, the first power module 131 and the second power module 132 may be rotated in a preset second rotational direction opposite to the first rotational direction. That is, the first power module 131 and the second power module 132 may be rotated in any one of the first rotational direction and the second rotational direction.

In one embodiment, the first rotational direction may be a direction in which the lawn mower robot 10 moves forward, that is, a counterclockwise direction when viewed from the left side of the lawn mower robot 10.

Similarly, the second rotational direction may be a direction in which the lawn mower robot 10 moves backward, that is, a clockwise direction when viewed from the left side of the lawn mower robot 10.

As described above, the first power module 131 and the second power module 132 may be controlled independently. Thus, the driving information may be classified into first driving information for controlling the first power module 131 and second driving information for controlling the second power module 132.

The first driving information includes control information for rotating or not rotating the first power module 131 in one of the first rotational direction and the second rotational direction.

Similarly, the second driving information includes control information for rotating or not rotating the second power module 132 in one of the first rotational direction and the second rotational direction.

For example, when the first driving information and the second driving information are all calculated as the first rotational direction and the first steering information and the second steering information are calculated as the same, the lawn mower robot 10 travels straight toward the front side.

On the contrary, when the first driving information and the second driving information are all calculated as the second rotational direction, and the first steering information and the second steering information are calculated as the same, the lawn mower robot 10 moves backward toward the rear side.

As another example, a case may be considered in which the first driving information is calculated as information related to non-rotation and the second driving information is calculated as the first or second rotational direction. In this case, the lawn mower robot 10 performs a curved motion centering on the first main wheel 121a connected to the first power module 131 as an axis.

On the contrary, a case may be considered in which the first driving information is calculated as the first or second rotational direction and the second driving information is calculated as information related to non-rotation. In this case, the lawn mower robot 10 performs a curved motion centering on the second main wheel 121b connected to the second power module 132 as an axis.

The driving information calculated by the driving information calculation unit 321, specifically, the first driving information and the second driving information, are transmitted to the operation control module 330 and the operation information storage module 420.

The steering information calculation unit 322 calculates the steering information. The steering information calculation unit 322 may calculate the steering information by using a control signal input through the control signal input module 310 or each information calculated by the incline part information calculation module 350.

The steering information calculated by the steering information calculation unit 322 may include information related to the number of turns or a rotational speed of each of the first power module 131 and the second power module 132.

As described above, the first power module 131 and the second power module 132 may be controlled independently. Thus, the steering information may be classified into first steering information for controlling the first power module 131 and second steering information for controlling the second power module 132.

The first steering information includes control information related to the number of turns or rotations or a rotational speed of the first power module 131. Similarly, the second steering information includes control information related to the number turns or rotations or a rotational speed of the second power module 132.

Therefore, when the first steering information and the second steering information are calculated differently, the lawn mower robot 10 may be rotated.

For example, when the first steering information is calculated to have a larger value than the second steering information, the rotational speed of the first power module 131 is faster than the rotational speed of the second power module 132. Accordingly, the lawn mower robot 10 performs a curved motion by which the second main wheel 121b connected to the second power module 132 is disposed radially inward.

On the contrary, when the second steering information is calculated to have a larger value than the first steering information, the rotational speed of the second power module 132 is faster than the rotational speed of the first power module 131. Accordingly, the lawn mower robot 10 performs a curved motion in which the first main wheel 121a connected to the first power module 131 is disposed radially inward.

The steering information calculated by the steering information calculation unit 322, specifically, the first steering information and the second steering information, are transmitted to the operation control module 330 and the operation information storage module 420.

According to the combination of the first and second driving information and the first and second steering information described above, the lawn mower robot 10 can travel in various directions.

The operation control module 330 controls the power module 130 according to the operation information calculated by the operation information calculation module 320. The operation control module 330 is electrically connected to the operation information calculation module 320.

The operation control module 330 includes a power module control unit 331.

The power module control unit 331 is configured to control the power module 130 in correspondence with the calculated operation information.

In detail, the power module control unit 331 may control the first power module 131 according to the calculated first driving information and first steering information. In addition, the power module control unit 331 may control the second power module 132 according to the calculated second driving information and second steering information.

The power module control unit 331 is electrically connected to the power module 130.

The detection information reception module 340 is configured to receive each information detected by the sensor part 200. The detection information reception module 340 is electrically connected to the sensor part 200.

Each information transmitted to the detection information reception module 340 is transferred to the incline part information calculation module 350 and used to calculate each information. The detection information reception module 340 is electrically connected to the incline part information calculation module 350.

The detection information reception module 340 is electrically connected to the database part 400. Each information detected by the sensor part 200 may be transmitted to the database part 400 through the detection information reception module 340.

The detection information reception module 340 includes an image information reception unit 341, a distance information reception unit 342, a position information reception unit 343, a rotation information reception unit 344, and a tilt information reception unit 345.

The image information reception unit 341 receives image information detected by the image sensor module 210. The image information reception unit 341 is electrically connected to the image sensor module 210.

The image information may be utilized to calculate whether there is an obstacle such as an arbitrary object on a path on which the lawn mower robot 10 travels.

Also, in the embodiment disclosed herein, the image information may be utilized to calculate incline part information related to whether or not there is an incline part on a travel path of the lawn mower robot 10, and inclination information which is information related to the incline part.

The image information may be provided to the user in the form of visualization information, so that the user can recognize a current task situation.

The image information received by the image information reception unit 341 may be delivered to a user terminal (not shown) in the form of visualization information. To this end, the image information reception unit 341 may be electrically connected to the terminal (not shown).

In one embodiment, the image information reception unit 341 and the terminal (not shown) may be connected in a manner such as Wi-Fi or Bluetooth.

The image information received by the image information reception unit 341 is transmitted to a detection information storage module 430 of the database part 400. The image information reception unit 341 is electrically connected to an image information storage unit 431.

The distance information reception unit 342 is configured to receive spaced distance information detected by the distance sensor module 220. The distance information reception unit 342 is electrically connected to the distance sensor module 220.

In the illustrated embodiment, the spaced distance information detected by the distance sensor module 220 may be classified into three pieces of information.

That is, the spaced distance information may be classified into a first spaced distance information in a first direction, second spaced distance information in a second direction, and third spaced distance information in a third direction. The distance sensor module 220 may receive all of the first to third spaced distance information.

The first to third spaced distance information may be used to calculate adjacent direction information to a direction in which a spaced distance between the lawn mower robot 10 and an arbitrary object is the shortest.

Each spaced distance information received by the distance information reception unit 342 is transmitted to the incline part information calculation module 350. The distance information reception unit 342 is electrically connected to an inclination information calculation unit 355 of the incline part information calculation module 350.

Each spaced distance information received by the distance information reception unit 342 is transmitted to the detection information storage module 430. The distance information reception unit 342 is electrically connected to a distance information storage unit 432.

The position information reception unit 343 is configured to receive position information detected by the location sensor module 230. The position information reception unit 343 is electrically connected to the position sensor module 230.

The position information received by the position information reception unit 343 is utilized to accurately calculate the position of the lawn mower robot 10. The position information is also used to calculate a distance from an incline part located on a travel path of the lawn mower robot 10, and distance information related to the incline part.

The position information received by the position information reception unit 343 is transmitted to the incline part information calculation module 350. The position information reception unit 343 is electrically connected to the incline part information calculation module 350.

The position information received by the position information reception unit 343 is transmitted to a position information storage unit 433 of the database part 400. The position information reception unit 343 is electrically connected to the position information storage unit 433.

The rotation information reception unit 344 is configured to receive rotation information detected by the rotation sensor module 240.

In detail, the rotation information reception unit 344 receives first rotation information detected by the first rotation sensor module 241 and second rotation information detected by the second rotation sensor module 242. The rotation information reception unit 344 is electrically connected to the rotation sensor module 240.

The rotation information received by the rotation information reception unit 344 is utilized to calculate information related to the travel of the lawn mower robot 10. The rotation information is also utilized to calculate whether the lawn mower robot 10 has entered an incline part (or inclined portion).

The rotation information received by the rotation information reception unit 344 is transmitted to the incline part information calculation module 350. The rotation information reception unit 344 is electrically connected to the incline part information calculation module 350.

The rotation information received by the rotation information reception unit 344 is transmitted to a rotation information storage unit 434 of the database part 400. The rotation information reception unit 344 is electrically connected to the rotation information storage unit 434.

The tilt information reception unit 345 is configured to receive tilt information detected by the tilt sensor module 250.

The tilt information received by the tilt information reception unit 345 is utilized to calculate whether the lawn mower robot 10 has entered an incline part. In addition, the tilt information is used to calculate an angle formed between the incline part, which the lawn mower robot 10 has entered, and a horizontal ground. Furthermore, the tilt information is used to calculate an angle formed between the lawn mower robot 10 and the horizontal ground.

The tilt information received by the tilt information reception unit 345 is transmitted to the incline part information calculation module 350. The tilt information reception unit 345 is electrically connected to the incline part information calculation module 350.

The tilt information received by the tilt information reception unit 345 is transmitted to a tilt information storage unit 435 of the database part 400. The tilt information reception unit 345 is electrically connected to the tilt information storage unit 435.

The incline part information calculation module 350 is configured to calculate information related to an operating state of the lawn mower robot 10 by using each information received by the detection information reception module 340.

In detail, the incline part information calculation module 350 may calculate information related to the travel of the lawn mower robot 10. In addition, the incline part information calculation module 350 may calculate information related to an external environment in which the lawn mower robot 10 performs a task.

The incline part information calculation module 350 is electrically connected to the detection information reception module 340. Each information transmitted from the sensor part 200 to the detection information reception module 340 may be transferred to the incline part information calculation module 350.

The incline part information calculation module 350 is electrically connected to the database part 400. Each information calculated by the incline part information calculation module 350 may be transferred to the database part 400.

Each information calculated by the incline part information calculation module 350 is transferred to the operation information calculation module 320 and used to calculate operating information. The incline part information calculation module 350 is electrically connected to the operation information calculation module 320.

The incline part information calculation module 350 includes an image information calculation unit 351, a position information calculation unit 352, a rotation information calculation unit 353, a tilt information calculation unit 354, and an inclination information calculation unit 355.

It will be understood that the image information calculation unit 351, the position information calculation unit 352, the rotation information calculation unit 353, and the tilt information calculation unit 354 are named according to background information which is necessary for the incline part information calculation module 350 to calculate incline part information.

Incline part information to be used in the following description may be defined as information related to whether an incline part is present on a travel path of the lawn mower robot 10.

In addition, inclination information may be defined as detailed information on the incline part, that is, information such as an extension distance of the incline part, an angle formed between the incline part and the ground, and the like.

In addition, a process in which each information calculation unit 351, 352, 353, 354, 355 to be described below calculates incline part information or inclination information is described as an example.

The image information calculation unit 351 is configured to calculate incline part information using detected image information. The image information calculation unit 351 is electrically connected to the image information reception unit 341.

The image information calculation unit 351 may calculate various kinds of information for calculating the incline part information from the image information received from the image information reception unit 341.

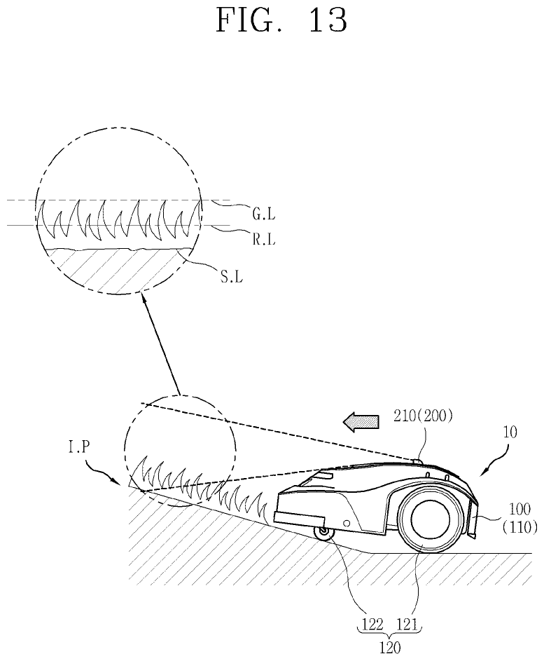

In one embodiment, the image information calculation unit 351 may extract a surface line S.L and a grass line G.L from image information, and compare the those extracted lines with a reference line R.L, so as to calculate incline part information (see FIG. 13). A detailed description thereof will be given later.

At this time, it is common that the ground in a natural state has unevenness to some extent. Therefore, when all the portions that the ground is partially recessed or partially protruded are determined as incline parts, the lawn mower robot 10 is difficult to normally operate or travel.

Therefore, the image information calculation unit 351 compares calculated incline part information with preset reference incline part information.

The reference incline part information may be regarded as information related to an incline part with a level at which a working environment of the lawn mower robot 10 is regarded as flat.

The reference incline part information may be variously determined depending on a technical specification and working environment of the lawn mower robot 10. The reference incline part information may be set to a specific value. That is, the reference incline part information may be defined as maximum unevenness (concave-convex) information by which it may be determined that the lawn mower robot 10 is traveling on a flat surface.

When the calculated incline part information is equal to or smaller than the reference incline part information, it may be calculated that such an incline part is not present on a path on which the lawn mower robot 10 travels.

On the contrary, when the calculated incline part information exceeds the reference incline part information, it may be calculated that the incline part is present on the path on which the lawn mower robot 10 travels.

When it is calculated that the incline part exists on the path that the lawn mower robot 10 proceeds, the image information calculation unit 351 transmits the calculated incline part information to the inclination information calculation unit 355. The image information calculation unit 351 and the inclination information calculation unit 355 are electrically connected to each other.

In addition, in the above-described case, the image information calculation unit 351 transmits the calculated incline part information to a calculation information storage module 440. The image information calculation unit 351 is electrically connected to the calculation information storage module 440.

The position information calculation unit 352 is configured to calculate incline part information using detected position information. The position information calculation unit 352 is electrically connected to the position information reception unit 343.

The position information calculation unit 352 may calculate various kinds of information for calculating the incline part information using the position information received from the position information reception unit 343.

As will be described later, a position information storage unit 433 of the database part 400 may also store information related to a position of an incline part (hereinafter, referred to as “position information on an incline part), which exists in an area where the lawn mower robot 10 performs a task, in the form of coordinate information.

At this time, the position information on the incline part stored in the position information storage unit 433 is information on the incline part which is not included in a range (range value) of the preset reference incline part information.

The position information calculation unit 352 may receive the position information on the incline part from the position information storage unit 433. The position information calculation unit 352 is electrically connected to the position information storage unit 433.

In addition, as described above, the position information may represent the position of the lawn mower robot 10 in the form of coordinate information.

Accordingly, the position information calculation unit 352 may calculate the incline part information by using the received position information on the incline part and the position information on the lawn mower robot 10.

That is, the position information calculation unit 352 calculates the incline part information by calculating distance information (hereinafter, referred to as “distance information”) between the position information on the lawn mower robot 10 and the position information on the incline part. That is, the position information calculation unit 352 calculates the incline part information in the form of distance information.

In this case, when even a case in which the calculated distance information is too large is calculated as presence of an incline part, the operation information calculation module 320 may be likely to calculate inaccurate operation information.

That is, operation information for performing a work on an incline part may be likely to be calculated even though the lawn mower robot 10 is sufficiently spaced apart from the incline part.

Therefore, the position information calculation unit 352 compares calculated incline part information with preset reference distance information.

The preset reference distance information may be defined as information related to a distance at which operation information for the lawn mower robot 10 to perform a work on the incline part is allowed to be calculated. That is, the reference distance information is a minimum distance by which the lawn mower robot 10 should be spaced apart from the incline part to perform a task according to a pre-input control signal.

The reference distance information may be variously determined depending on a technical specification and working environment of the lawn mower robot 10. The reference distance information may be set to a specific value.

When the calculated distance information is smaller than the reference distance information, it may be calculated that operation information for the lawn mower robot 10 to perform a task on the incline part is needed.

On the contrary, when the calculated distance information is greater than or equal to the reference distance information, it may be calculated that the lawn mower robot 10 can perform a task according to a pre-input control signal.

When it is calculated that the operation information for the lawn mower robot 10 to perform the task on the incline part is needed, the position information calculation unit 352 transmits the calculated incline part information to the inclination information calculation unit 355. The position information calculation unit 352 and the inclination information calculation unit 355 are electrically connected to each other.

In this case, the position information calculation unit 352 also transfers the calculated incline part information to a calculation information storage module 440. The position information calculation unit 352 is electrically connected to the calculation information storage module 440.

The rotation information calculation unit 353 is configured to calculate incline part information using detected rotation information. The rotation information calculation unit 353 is electrically connected to the rotation information reception unit 344.

The rotation information calculation unit 353 may calculate various pieces of information for calculating the incline part information from the rotation information received from the rotation information reception unit 344.

In detail, the rotation information calculation unit 353 may calculate a travel distance of the lawn mower robot 10 using the received rotation information, a time for which the lawn mower robot 10 is operated, and a pre-input control signal. The rotation information calculation unit 353 is electrically connected to the control signal input module 310 and the operation information calculation module 320.

When the lawn mower robot 10 enters an incline part, a situation in which the main wheel 121 slips may occur. In this case, a calculated travel distance and a distance actually moved by the lawn mower robot 10 are different from each other.

The rotation information calculation unit 353 compares position information on the lawn mower robot 10 with the calculated travel distance. That is, the rotation information calculation unit 353 compares predicted position information on the lawn mower robot 10 (position information according to the calculated travel distance) and actual position information (position information) on the lawn mower robot 10.

When the situation in which the main wheel 121 slips occurs, the predicted position information and the actual position information may be calculated differently. In this case, the rotation information calculation unit 353 may calculate incline part information as the lawn mower robot 10 having entered the incline part existing on its travel path.

On the contrary, when the situation in which the main wheel 121 slips does not occur, the predicted position information and the actual position information may be calculated the same as or similar to each other. In this case, the rotation information calculation unit 353 may calculate incline part information as the lawn mower robot 10 having not entered the incline part.

In this case, when all the cases where the predicted position information and the actual position information are different from each other are calculated as presence of an incline part, the operation information calculation module 320 may calculate inaccurate operation information.

That is, operation information for the lawn mower robot 10 to perform a work on an incline part may be likely to be calculated even though the lawn mower robot 10 is in an environment it can fully perform a task like on a flat surface.

Therefore, the rotation information calculation unit 353 compares calculated position information with preset reference position information.

The preset reference position information may be defined as information related to a position where operation information for the lawn mower robot 10 to perform a work on an incline part is allowed to be calculated. In other words, the reference position information is information on a position which the lawn mower robot 10 should reach in consideration of an error range when a task is performed according to a pre-input control signal.

The reference position information may be variously determined depending on a technical specification and working environment of the lawn mower robot 10. The reference distance information may be set to a specific time value.

As described above, the lawn mower robot 10 travels along a preset path. The position of the lawn mower robot 10 changes according to a lapse of time while the lawn mower robot 10 travels on the preset path. Therefore, the reference position information and predicted position information may be calculated in the form of time information.

That is, the rotation information calculation unit 353 calculates incline part information in the form of position information and time information.

Therefore, when the predicted position information calculated in the form of time information is smaller than the reference position information also calculated in the form of time information, it may be calculated that the operation information for the lawn mower robot 10 to perform a task on the incline part is needed.

On the contrary, when the predicted position information calculated in the form of time information is equal to or greater than the reference position information also calculated in the form of time information, it may be calculated that the lawn mower robot 10 can perform a task according to a pre-input control signal.

When it is calculated that the operation information for the lawn mower robot 10 to perform the task on the incline part is needed, the rotation information calculation unit 353 transmits the calculated incline part information to the inclination information calculation unit 355. The rotation information calculation unit 353 and the inclination information calculation unit 355 are electrically connected to each other.

In this case, the rotation information calculation unit 353 also transfers the calculated incline part information to the calculation information storage module 440. The rotation information calculation unit 353 is electrically connected to the calculation information storage module 440.

The tilt information calculation unit 354 is configured to calculate incline part information using detected tilt information. The tilt information calculation unit 354 is electrically connected to the tilt information reception unit 345.

The tilt information calculation unit 354 may calculate various pieces of information for calculating the incline part information from the tilt information received from the tilt information reception unit 345.

When the lawn mower robot 10 enters an incline part, angle information that the lawn mower robot 10 makes with the ground or a horizontal surface changes.

The tilt information calculation unit 354 calculates incline part information including the angle information by using the received tilt information. In one embodiment, the angle information may be determined in the range of 0° to 90°.

At this time, it is common that the ground in a natural state has unevenness to some extent. Therefore, the lawn mower robot 10 may travel on the ground in an inclined state by a predetermined angle.

That is, when all the cases where the calculated angle information is not 0° are determined as a situation in which the lawn mower robot 10 has entered an incline part, the lawn mower robot 10 is difficult to operate normally.

Therefore, the tilt information calculation unit 354 compares the calculated angle information with preset reference angle information. That is, the tilt information calculation unit 354 calculates incline part information in the form of angle information.

The reference angle information may be defined as information related to an incline part with a level at which a working environment of the lawn mower robot 10 is regarded as flat.

The reference angle information may be variously determined according to a technical specification and working environment of the lawn mower robot 10. The reference incline part information may be set to a specific value.

That is, the reference incline part information is a maximum tilt information related to the ground on which the lawn mower robot 10 can operate according to operation information for performing a task on a flat surface.

When the calculated angle information exceeds the reference angle information, it may be calculated that the lawn mower robot 10 has entered the incline part.

On the contrary, when the calculated angle information is equal to or smaller than the reference angle information, it may be calculated the lawn mower robot 10 is traveling on the flat surface.

When the lawn mower robot 10 is calculated as having entered the incline part, the tilt information calculation unit 354 transmits the calculated incline part information to the inclination information calculation unit 355. The tilt information calculation unit 354 and the inclination information calculation unit 355 are electrically connected to each other.

In this case, the tilt information calculation unit 354 also transfers the calculated incline part information to the calculation information storage module 440. The tilt information calculation unit 354 is electrically connected to the calculation information storage module 440.

The inclination information calculation unit 355 is configured to calculate inclination information that is detailed information on the incline part by using the received incline part information.

The inclination information calculated by the inclination information calculation unit 355 is transmitted to the operation information calculation module 320. The inclination information calculation unit 355 is electrically connected to the operation information calculation module 320.

The inclination information calculation unit 355 receives incline part information calculated by the image information calculation unit 351, the position information calculation unit 352, the rotation information calculation unit 353, and the tilt information calculation unit 354, respectively. The inclination information calculation unit 355 is electrically connected to each of the calculation units 351, 352, 353, and 354.

As described above, when operation information for the lawn mower robot 10 to operate on an incline part should be calculated, the calculated incline part information is transmitted to the inclination information calculation unit 355.

That is, the inclination information calculation unit 355 receives inclination information calculated as a situation in which the lawn mower robot 10 cannot operate according to operation information for performing a task on a flat surface.

Thus, the inclination information calculation unit 355 calculates detailed information related to the incline part, in order for the lawn mower robot 10 to operate on the incline part or avoid the incline part.

The inclination information calculation unit 355 may be configured to calculate arbitrary information for specifying an incline part. In one embodiment, the inclination information calculation unit 355 may calculate angle information and extension distance information related to the incline part.

That is, the inclination information may include angle information and extension distance information.

The angle information may be defined as information related to an angle that the incline part makes with a horizontal surface or the ground. The angle information may be calculated as a specific value in the range of −90° to 90° with respect to the ground.

The extension distance information may be defined as information related to a distance by which the incline part extends from the horizontal surface or the ground to its top. That is, the extension distance information is a distance by which one side surface of the incline part facing the lawn mower robot 10 extends from the horizontal plane or the ground to the top of the incline part opposite to the lawn mower robot 10.

The angle information may be calculated using information detected by each sensor module 210, 220, 230, 240, and 250, and incline part information calculated by each calculation unit 351, 352, 353, and 354.

Similarly, the extension distance information may be calculated using information detected by each sensor module 210, 220, 230, 240, and 250 and incline part information calculated by each calculation unit 351, 352, 353, and 354.

To this end, the inclination information calculation unit 355 is electrically connected to each of the calculation units 351, 352, 353, and 354.

In addition, the inclination information calculation unit 355 may receive information necessary for calculating inclination information from the database part 400. The inclination information calculation unit 355 is electrically connected to the database part 400.

The process of calculating the angle information and the extension distance information will now be described in detail.

In one embodiment, the angle information and the extension distance information may be calculated using detected image information and rotation information.

Assuming that an incline part is located on a path on which the lawn mower robot 10 travels, the image sensor module 210 detects a portion where one side surface of the incline part facing the lawn mower robot 10 is in contact with the ground. In addition, the rotation sensor module 240 detects a rotational speed or the number of turns of the main wheel 121.

When a top of the incline part is detected together with the portion, a distance between the top of the incline part and the portion may become farther as the lawn mower robot 10 approaches the incline part.

Thus, the increase in the distance between the top of the incline part and the portion may be expressed by a function of a change of time.

Using the detected rotational speed or turns of the main wheel 121 and the time, a movement distance of the lawn mower robot 10 may be calculated.

Accordingly, since the distance change between the top of the incline part and the portion and the movement distance of the lawn mower robot 10 can be known, angle information and extension distance information may be calculated using the Pythagorean theorem and a proportional expression.

In another embodiment, the angle information and the extension distance information may be calculated using detected position information.

The position information storage unit 433 stores information on position and height of an incline part. The inclination information calculation unit 355 may receive the information.

Accordingly, the inclination information calculation unit 355 may calculate angle information and extension distance information from the information using the Pythagorean theorem and the proportional expression.

In addition to the foregoing embodiments, the inclination information calculation unit 355 may also calculate angle information and extension distance information by using detected spaced distance information and tilt information.

The inclination information calculated by the inclination information calculation unit 355, specifically, the angle information and the extension distance information are transmitted to the operation information calculation module 320. In this case, the incline part information calculated by each of the calculation units 351, 352, 353, and 354 may also be transmitted to the operation information calculation module 320.

(4) Description of Database Part 400

The database part 400 stores various kinds of information related to the operation of the lawn mower robot 10.

The database part 400 may be provided in any form capable of inputting, outputting, and storing information. In one embodiment, the database part 400 may be provided in the form of an SD card, a micro SD card, a USB memory, an SSD, or the like.

The database part 400 is electrically connected to the control signal input module 310. A control signal input to the control signal input module 310 may be transmitted to the database part 400 and stored.

The database part 400 is electrically connected to the operation information calculation module 320. Operation information calculated by the operation information calculation module 320 may be transferred to the database part 400 and stored.

The database part 400 is electrically connected to the sensor part 200 through the detection information reception module 340. Each detection information detected by the sensor part 200 may be transferred to the database part 400 and stored.

The database part 400 is electrically connected to the incline part information calculation module 350. Each information calculated by the incline part information calculation module 350 may be transferred to the database part 400 and stored.

Each of the stored information may be stored by mapping to an operating time and environment of the lawn mower robot 10. That is, each information related to a task performed by the lawn mower robot 10 at a specific time point and a small (partial, local) area on which the lawn mower robot 10 has performed the task may be stored in a mapping manner.

The stored data may be used as big data for the lawn mower robot 10 to efficiently perform tasks. The lawn mower robot 10 may also perform tasks more effectively by learning the stored information through artificial intelligence (AI).

The database part 400 includes a control signal storage module 410, an operation information storage module 420, a detection information storage module 430, and a calculation information storage module 440. Each of the modules 410, 420, 430, and 440 may be electrically connected to one another.

The control signal storage module 410 stores a control signal input to the control signal input module 310. The control signal storage module 410 is electrically connected to the control signal input module 310.

The control signal stored in the control signal storage module 410 may be mapped to environment information in which the lawn mower robot 10 operates and then stored. Accordingly, the control signal storage module 410 may classify and store a control signal with respect to a task desired by the user according to a specific environment.

The control signals stored in the control signal storage module 410 may be utilized when the user wants to perform tasks automatically. That is, when an environment of a time for which the lawn mower robot 10 operates is similar to a specific environment to which the stored control signal is mapped, the lawn mower robot 10 may be controlled according to the corresponding control signal.

The operation information storage module 420 stores operation information calculated by the operation information calculation module 320. The operation information storage module 420 is electrically connected to the operation information calculation module 320.

The operation information storage module 420 may store operation information according to a specific control signal. The operation information storage module 420 is electrically connected to the control signal storage module 410.

The operation information stored in the operation information storage module 420 may be mapped to environment information in which the lawn mower robot 10 operates and a control information for operating the lawn mower robot 10 and then stored. Accordingly, the operation information storage module 420 may classify and store operation information on a task to be performed by the lawn mower robot 10 according to a specific environment and a specific control signal.

The operation information stored in the operation information storage module 420 may be utilized when the user wants to perform a task automatically. That is, when an environment of a time for which the lawn mower robot 10 operates or a control signal for operating the lawn mower robot 10 is similar to a specific environment or specific control signal mapped with operation information, the power module 130 may be operated according to the corresponding operation information.

As described above, the operation information includes driving information and steering information. Accordingly, the driving information and the steering information may be classified and stored in the operation information storage module 420.

The detection information storage module 430 stores each information detected by the sensor part 200. Each information detected by the sensor part 200 may be transmitted to the detection information storage module 430 through the detection information reception module 340. The detection information storage module 430 is electrically connected to the detection information reception module 340.

The detection information storage module 430 may store detection information according to a specific control signal and specific operation information. The detection information storage module 430 is electrically connected to the control signal storage module 410 and the operation information storage module 420.

The operation information stored in the detection information storage module 430 may be mapped to the environment information, the control signal, and the operation information all related to the operation of the lawn mower robot 10, and then stored.

That is, the detection information storage module 430 may classify and store information on an external environment, which is detected while the lawn mower robot 10 performs a task, according to a specific environment, a control signal, and operation information.

As described above, the information detected by the sensor part 200 may include image information, spaced distance information, position information, and rotation information. Accordingly, the detection information storage module 430 includes an image information storage unit 431, a distance information storage unit 432, a position information storage unit 433, a rotation information storage unit 434, and a tilt information storage unit 435.

The image information storage unit 431 stores transferred image information. The distance information storage unit 432 stores transferred spaced distance information, and the position information storage unit 433 stores transferred position information.

In particular, the position information storage unit 433 may store information related to a terrain at a specific location in an area where the lawn mower robot 10 is performing a work.

In addition, the rotation information storage unit 434 stores transferred rotation information. The tilt information storage unit 435 stores transferred tilt information.

The information storage units 431, 432, 433, 434, and 435 may be electrically connected to one another. In addition, the information stored in each of the information storage units 431, 432, 433, 434, and 435 may be mapped to one another according to a working time, a working environment, and the like.

Therefore, when the lawn mower robot 10 is performing a task at a specific position at a specific time, it may be determined whether an obstacle such as a stone or the like is present, whether the obstacle is located adjacent to a specific local (small) area, and the like.

As a result, the lawn mower robot 10 can recognize in advance the presence of the obstacle at the specific position while performing a task, and thus avoid the obstacle.

Furthermore, in an area where the lawn mower robot 10 performs a work, a position where an incline part is present may be recognized, and operation information related to it may be calculated accordingly.

This may result in improving operation efficiency of the lawn mower robot 10.

The calculation information storage module 440 stores each information calculated by the incline part information calculation module 350. The calculation information storage module 440 is electrically connected to the incline part information calculation module 350.

Each calculated information stored in the operation information storage module 440 may be mapped to a control signal, operation information, and detection information, respectively. The calculation information storage module 440 is electrically connected to the control signal storage module 410, the operation information storage module 420, and the detection information storage module 430.

Therefore, the information calculated according to the specific control signal, operation information and detection information can be databased.

As a result, when an unpredictable situation occurs while the lawn mower robot 10 is operating, immediate response to the situation can be made by utilizing each information stored in the calculation information storage module 440 without repetitive calculation. Accordingly, the operation efficiency of the lawn mower robot 10 can be improved.

As described above, the incline part information calculation module 350 calculates incline part information and inclination information. Accordingly, the calculation information storage module 440 includes an incline part information storage unit 441 and an inclination information storage unit 442.

The incline part information storage unit 441 stores the transmitted incline part information. The incline part information, as aforementioned, is the information calculated by the image information calculation unit 351, the position information calculation unit 352, the rotation information calculation unit 353, and the tilt information calculation unit 354.

In addition, the inclination information storage unit 442 stores the transmitted inclination information. As described above, the inclination information includes angle information and extension distance information.

The incline part information storage unit 441 and the inclination information storage unit 442 are electrically connected to each other.

The detection process of the sensor part 200, the information processing and calculation process of the controller 300, and the storing process of the database part 400 may be performed in real time. In addition, each of the processes may be performed continuously.

### 3. Description of Method for Controlling Lawn Mower Robot 10 According to Embodiment

In a method for controlling a lawn mower robot 10 according to an embodiment disclosed herein, when an incline part (inclined portion) is located on a travel path of the lawn mower robot 10, the lawn mower robot 10 can be efficiently controlled.

That is, in this case, operation information for operating the lawn mower robot 10 on the incline part may be calculated, or operation information for allowing the lawn mower robot 10 to avoid the incline part may be calculated.

The control may be achieved by the aforementioned configurations without separately receiving a control signal input by the user.

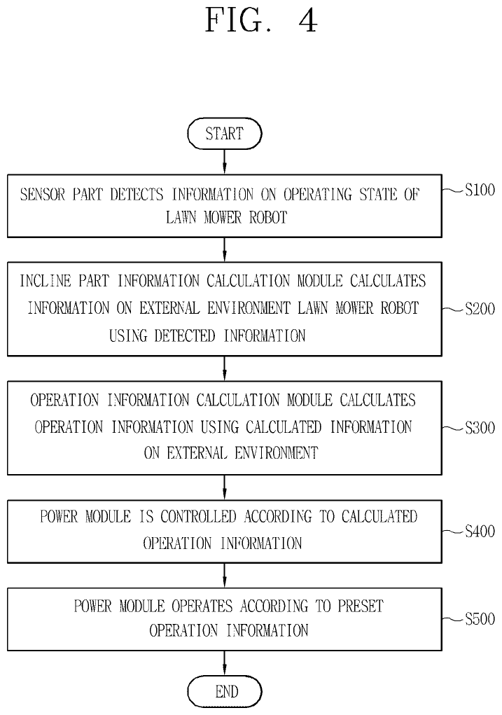

Hereinafter, a method for controlling a lawn mower robot according to an embodiment will be described in detail with reference to FIGS. 4 to 9.

(1) Description of Step S100 in which the Sensor Part 200 Detects Information on an Operating State of the Lawn Mower Robot 10

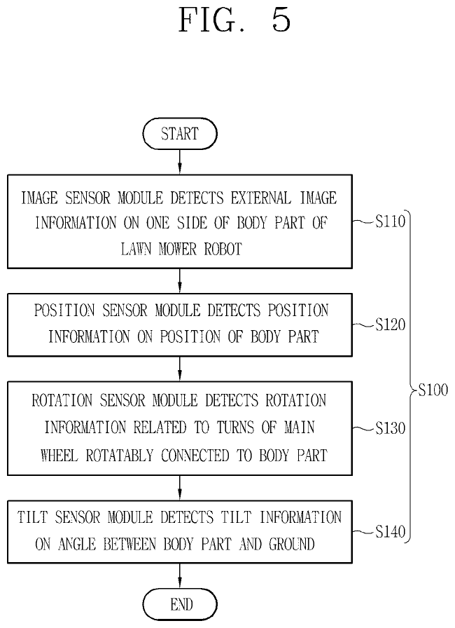

This is a step in which the sensor part 200 detects information on an external environment of the lawn mower robot 10 and information on an operating state of the lawn mower robot 10. Hereinafter, this step will be described in detail with reference to FIG. 5.

First, the image sensor module 210 detects image information on an external environment of one side of the lawn mower robot 10 (S110). The image sensor module 210 may detect external image information related to the body part 100 of the lawn mower robot 10.

The one side is a side facing a direction in which the lawn mower robot 10 travels. In one embodiment, the one side may be a front side of the lawn mower robot 10.

In addition, although not shown, a step in which the distance sensor module 220 detects spaced distance information from an arbitrary object may be included. In this step, the first to third distance sensor modules 221, 222, and 223 may detect first to third distance information, respectively.

In addition, the position sensor module 230 detects position information which is information related to a position of the lawn mower robot 10 (S120). The position sensor module 230 may detect position information related to the body part 100 of the lawn mower robot 10.

The position information detected by the position sensor module 230 may be in the form of coordinate information.

In addition, the rotation sensor module 240 detects rotation information that is information on the number of turns or rotations of the main wheel 121 that is rotatably connected to the body part 100 of the lawn mower robot 10 (S130).

The main wheel 121 includes the first main wheel 121a and the second main wheel 121a. Therefore, the detected rotation information may include first rotation information related to the first main wheel 121a and second rotation information related to the second main wheel 121b.

In addition, the tilt sensor module 250 detects tilt information on an angle formed between the body part 100 of the lawn mower robot 10 and the ground (S140).

The detected tilt information may be in the form of angle information.

The order in which the respective sensor modules 210, 220, 230, 240, and 250 detect information may change. Alternatively, each sensor module 210, 220, 230, 240, and 250 may detect information at the same time or at different times.

Each information detected by the sensor modules 210, 220, 230, 240, and 250 is transmitted to the detection information reception module 340.

In detail, the image information detected by the image sensor module 210 is transmitted to the image information reception unit 341. The distance information detected by the distance sensor module 220 is transmitted to the distance information reception unit 342. The position information detected by the position sensor module 230 is transmitted to the position information reception unit 343.

In addition, the rotation information detected by the rotation sensor module 240 is transmitted to the rotation information reception unit 344. The tilt information detected by the tilt sensor module 250 is transmitted to the tilt information reception unit 345.

(2) Description of Step (S200) in which the Incline Part Information Calculation Module 350 Calculates Information on an External Environment of the Lawn Mower Robot 10 Using the Detected Information

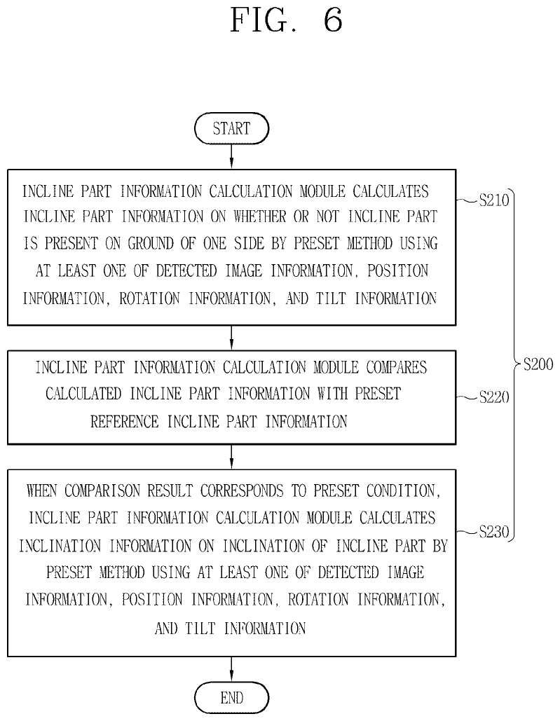

The controller 300 receives each detected information, and calculates incline part information and inclination information using the received information. Hereinafter, this step will be described in detail with reference to FIG. 6.

First, the incline part information calculation module 350 receives each detected information from the detection information reception module 340.

The incline part information calculation module 350 calculates incline part information that is information related to whether or not an incline part is present on the ground of the one side, by a preset method using at least one of the detected image information, position information, rotation information and tilt information (S210).

In detail, the image information calculation unit 351 calculates the incline part information using the sensed image information. The position information calculation unit 352 calculates the incline part information using the detected position information.

In addition, the rotation information calculation unit 353 calculates the incline part information using the detected rotation information. The tilt information calculation unit 354 calculates the incline part information using the detected tilt information.

The process in which each of the calculation units 351, 352, 353, and 354 calculates the incline part information by using each detected information is as described above.

In addition, the incline part information calculation module 350 compares the calculated incline part information with preset reference incline part information (S220).

The process in which each of the calculation units 351, 352, 353, and 354 compares the calculated incline part information with the preset reference incline part information is as described above.

When the comparison result corresponds to a preset condition, the incline part information calculation module 350 calculates inclination information that is information related to an inclination of the incline part, by a preset method using at least one of the detected image information, position information, rotation information and tilt information (S230).

The preset condition is as described above.

In detail, when the incline part information calculated by the image information calculation unit 351 exceeds the reference incline part information, it may be calculated that the incline part exists on a path along which the lawn mower robot 10 proceeds.

In addition, when the incline part information calculated by the position information calculation unit 352 is smaller than reference distance information, it may be calculated that operation information for the lawn mower robot 10 to perform a work on the incline part is needed.

In addition, when the incline part information calculated by the rotation information calculation unit 353 in the form of time information is shorter than reference position information calculated in the form of time information, it may be calculated that operation information for the lawn mower robot 10 to perform a task on the incline part is needed.

In addition, when the incline part information calculated by the tilt information calculation unit 354 exceeds reference angle information, it may be calculated that the lawn mower robot 10 has entered the incline part.

It will be understood that the preset reference incline part information includes the reference distance information, the reference position information, and the reference angle information.

That is, the preset condition is that the calculation result of each of the information calculation units 351, 352, 353, and 354 indicates that the incline part exists in the direction in which the lawn mower robot 10 proceeds.

Thus, the incline part information calculated by each of the information calculation units 351, 352, 353, and 354 is transmitted to the inclination information calculation unit 355. The inclination information calculation unit 355 calculates inclination information using the transmitted incline part information. As described above, the inclination information includes angle information and extension distance information.

The order of the calculation processes may change. In addition, the calculation processes may be performed at the same time or at different times.

The inclination information calculated by the inclination information calculation unit 355 is transmitted to the operation information calculation module 320. At this time, the incline part information calculated by the inclination information calculation unit 355 is also transmitted to the operation information calculation module 320.

(3) Description of Step (S300) in which the Operation Information Calculation Module 320 Calculates Operation Information Using Calculated Information on External Environment

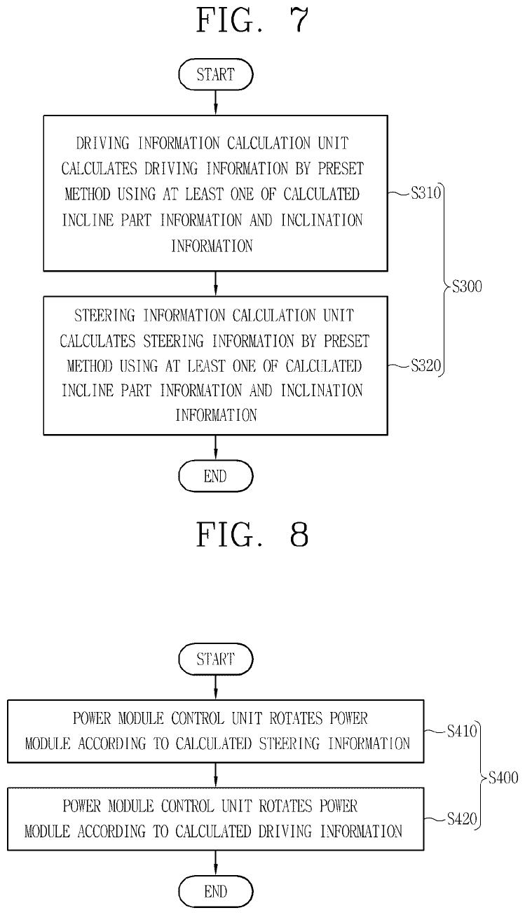

This is a step in which the operation information calculation module 320 calculates operation information for operating the power module 130 using at least one of the transferred incline part information and inclination information. Hereinafter, this step will be described in detail with reference to FIG. 7. The operation information calculation module 320 receives the incline part information and the inclination information from the inclination information calculation unit 355.

In addition, the driving information calculation unit 321 calculates driving information by a preset method using at least one of the transferred incline part information and inclination information (S310).

The preset method may be classified into two ways.

That is, a way of allowing the lawn mower robot 10 to travel forward while performing a task along the incline part, and another way of allowing the lawn mower robot 10 to avoid the incline part may be considered.

First, a case in which the lawn mower robot 10 moves while performing a work along the incline part will be described.

The lawn mower robot 10 should move to the front in order to travel along the incline part.

Therefore, the driving information calculation unit 321 calculates first driving information and second driving information as a first rotational direction, respectively.

Next, a case in which the lawn mower robot 10 moves while avoiding the incline part will be described.

In this case, the lawn mower robot 10 should be rotated to the left or right. The rotation of the lawn mower robot 10 may be controlled according to steering information.

Therefore, the driving information calculation unit 321 calculates first driving information and second driving information as a first rotational direction, respectively.

In addition, it may be considered that the lawn mower robot 10 has already entered the incline part. In this case, the lawn mower robot 10 should be reversed by a predetermined distance.

Therefore, the driving information calculation unit 321 calculates first driving information and second driving information as a second rotational direction.

Alternatively, the driving information calculation unit 321 may calculate one of the first driving information and the second driving information as the first rotational direction and the other as the second rotational direction. In this case, the lawn mower robot 10 may move backward by rotating in either of the left or right direction.

Next, the steering information calculation unit 322 calculates steering information by a preset method using at least one of the calculated incline part information and inclination information (S320).

The preset method may be classified into two ways.

In addition, as described above, a way of allowing the lawn mower robot 10 to travel forward while performing a task along the incline part, and another way of allowing the lawn mower robot 10 to avoid the incline part may be considered.

First, a case in which the lawn mower robot 10 moves while performing a work along the incline part will be described.

In order for the lawn mower robot 10 to move along the incline part, more power is required than when the lawn mower robot 10 moves on a flat surface.

Accordingly, the driving information calculation unit 321 calculates the first steering information and the second steering information so that the first power module 131 and the second power module 132 rotate faster.

Furthermore, when the lawn mower robot 10 moves along the incline part, it is more efficient to move zigzag than to go straight. In addition, as the lawn mower robot 10 moves zigzag, a task area of the lawn mower robot 10 may increase.

Therefore, the steering information calculation unit 322 calculates the first steering information and the second steering information in a manner that steering degrees of the first and second steering information change alternately. That is, a situation in which the first steering information has a larger value and a situation in which the second steering information has a larger value are alternately repeated.

Next, a case in which the lawn mower robot 10 moves while avoiding the incline part will be described.

In this case, the lawn mower robot 10 should be rotated to the left or to the right.

Accordingly, the steering information calculation unit 332 calculates the first steering information and the second steering information in a manner that either one of the first steering information and the second steering information has a larger value.

This may allow the lawn mower robot 10 to be rotated to the left or the right, and to thusly proceed while avoiding the incline part.

The order of the calculation process of the driving information and the steering information may change. In addition, the calculation process of the driving information and the steering information may be performed at the same time or at different times.

Each driving information calculated by the driving information calculation unit 321 and each steering information calculated by the steering information calculation unit 322 are transmitted to the operation control module 330.

(4) Description of Step (S400) in which the Power Module 130 is Controlled According to Calculated Operation Information

This is a step in which the power module 130 operates according to the operation information calculated by the operation information calculation module 320. Hereinafter, this step will be described in detail with reference to FIG. 8.

The power module control unit 331 rotates the power module 130 according to the calculated steering information (S410).

That is, the power module control unit 331 rotates the first power module 131 and the second power module 132 according to the first steering information and the second steering information calculated by the steering information calculation unit 322.

In addition, the power module control unit 331 rotates the power module 130 according to the calculated driving information (S420).

That is, the power module control unit 331 rotates the first power module 131 and the second power module 132 in the first rotational direction or the second rotational direction or stops the first power module 131 and the second power module 132, according to the first driving information and the second driving information calculated by the driving information calculation unit 321.

Accordingly, the lawn mower robot 10 may move while performing a work along the incline part. Or, the lawn mower robot 10 may proceed while avoiding the incline part.

(5) Description of Step (S500) in which the Power Module 130 Operates According to Preset Operation Information

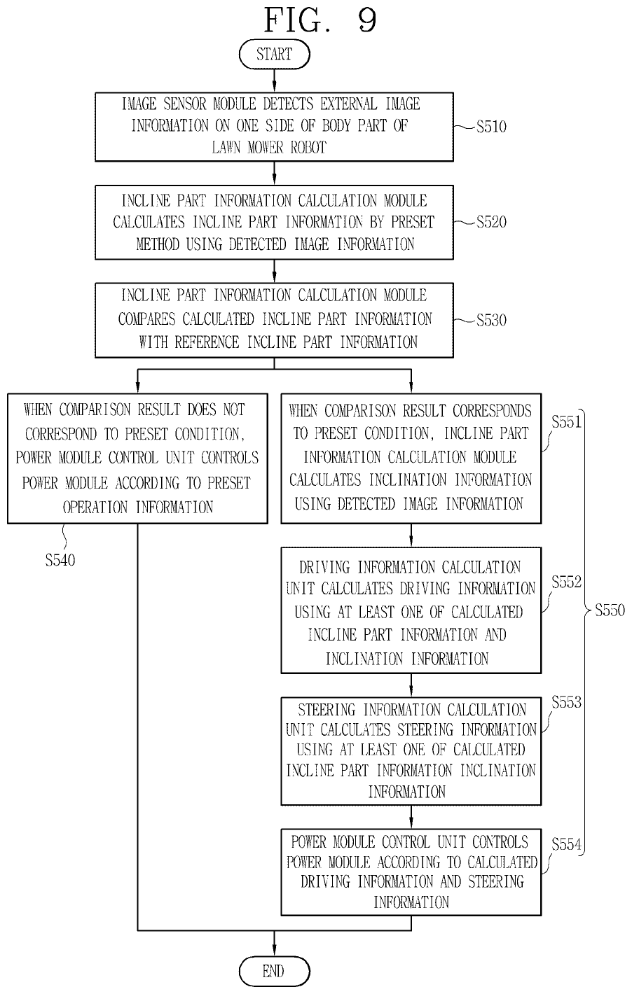

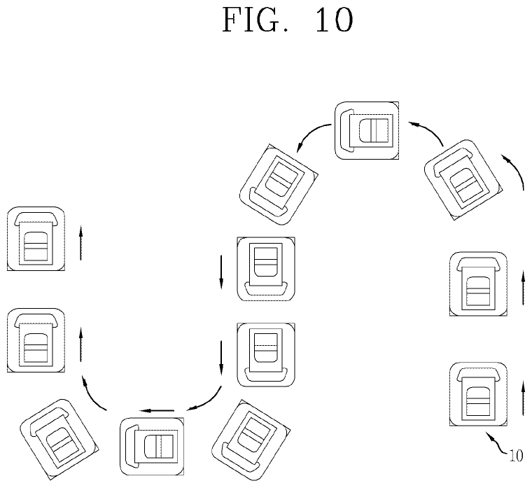

After the lawn mower robot 10 passes or avoids the incline part through the steps, the lawn mower robot 10 operates according to a pre-input control signal. That is, in this step, the lawn mower robot 10 restarts a work that has been expected to be performed. Hereinafter, this step will be described in detail with reference to FIG. 9.

First, the image sensor module 210 detects external image information on one side of the body part 100 of the lawn mower robot 10 (S510).

This step is performed to detect whether an incline part is present on a path on which the lawn mower robot 10 is to travel.

Although not shown, those steps S120, S130, and S140 may be performed at the same time or at different times.

Each detected information is transmitted to the incline part information calculation module 350 through the detection information reception module 340.

In addition, the incline part information calculation module 350 calculates incline part information by a preset method using the detected image information (S520).

Although not shown, as described above, the incline part information calculation module 350 may calculate the incline part information using any one of image information, position information, rotation information, and tilt information.

The preset method for calculating the incline part information at the incline part information calculation module 350 is as described above.

The incline part information calculation module 350 compares the calculated incline part information with reference incline part information (S530). According to the result of the comparison, the subsequent steps are divided.

When the comparison result does not correspond to a preset condition, the power module control unit 331 controls the power module 130 according to preset operation information (S540).

This step is a case where the incline part does not exist on the path that the lawn mower robot 10 travels. The preset condition is as described above.

Therefore, the power module control unit 331 controls the power module 130 according to preset operation information, that is, operation information that is calculated according to a pre-input control signal. Accordingly, the lawn mower robot 10 continues a scheduled work.

When the comparison result corresponds to the preset condition, information related to the incline part is calculated to pass or avoid the incline part (S550). That is, the following steps may be understood to be the same as the aforementioned steps S100, S200, S300 and S400.

The incline part information calculation module 350 calculates inclination information by using the detected image information (S551).

Although not shown, the incline part information calculation module 350 may calculate inclination information by using any one of image information, position information, rotation information, and tilt information.

The calculated inclination information and the transferred incline part information are transmitted to the operation information calculation module 320.

The driving information calculation unit 321 calculates driving information by using at least one of the calculated incline part information and inclination information (S552). In addition, the steering information calculation unit 322 calculates steering information by using at least one of the calculated incline part information and inclination information (S553).

The processes of calculating the driving information and the steering information are as described above. The calculated driving information and steering information are transmitted to the power module control unit 331.

The power module control unit 331 controls the power module 130 according to the calculated driving information and steering information (S554).

Accordingly, the lawn mower robot 10 can pass or avoid the incline part.

In addition, although not shown, after the step S554 is performed, the process may go to step S500 again. That is, the aforementioned steps S100 to S500 may be repeated while the lawn mower robot 10 is operating.

### 4. Description of Process in which the Lawn Mower Robot 10 According to Embodiment Detects an Incline Part, and is Controlled Accordingly

Hereinafter, description will be given in detail of a process in which the lawn mower robot 10 is operated and performs a task according to the respective components of the lawn mower robot 10 and the control method of the lawn mower robot 10, with reference to FIGS. 10 to 18.

Referring to FIG. 10, a process in which the lawn mower robot 10 performs a work in a preset area is illustrated. The lawn mower robot 10 travels along a preset path while mowing the lawn existing on the path.

In the illustrated embodiment, the lawn mower robot 10 moves upward by a predetermined distance and then rotates counterclockwise to move to the left. After moving to the left, the lawn mower robot 10 advances by a predetermined distance, and then rotates counterclockwise again to move downward.

After moving downward by a predetermined distance, the lawn mower robot 10 rotates clockwise to move to the left again by a predetermined distance. In addition, the lawn mower robot 10 rotates clockwise again to move upward by a predetermined distance.

That is, the lawn mower robot 10 is configured to move up and down in a preset area, in a manner of mowing the lawn through zigzag movement. The process may be repeated until the lawn mower robot 10 finishes the task according to a pre-input control signal.

In the illustrated embodiment, the path where the lawn mower robot 10 moves upward and the path where the lawn mower robot 10 moves downward are slightly spaced apart from each other. However, it will be understood that the two paths are actually adjacent to each other.

The preset area may be an area that is predetermined for the lawn mower robot 10 to perform a task. Although not shown, the preset area may be partitioned by a virtual partition line input by a user through a smartphone or the like. Alternatively, the preset area may be partitioned by a physical member in the form of a fence.

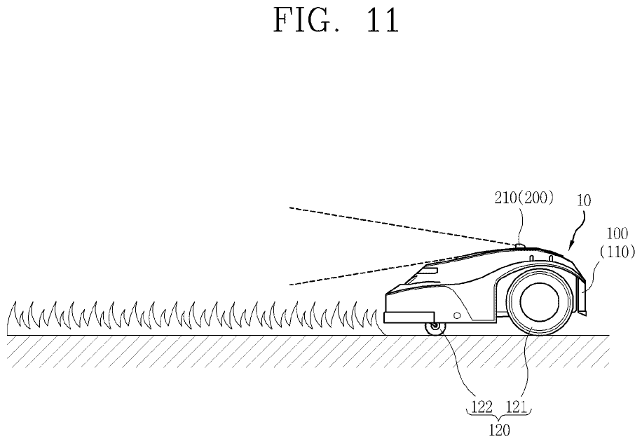

FIG. 11 is a lateral view illustrating that the lawn mower robot 10 moves on the ground. In the illustrated embodiment, the ground is formed flat without an incline.

While the lawn mower robot 10 is traveling along the ground, the image sensor module 210 detects image information on one side at outside of the lawn mower robot 10, namely, a left environment in the illustrated embodiment.

Although not shown, the distance sensor module 220, the position sensor module 230, the rotation sensor module 240, and the tilt sensor module 250 also detect spaced distance information, position information, rotation information, and tilt information at the same time or at different times.

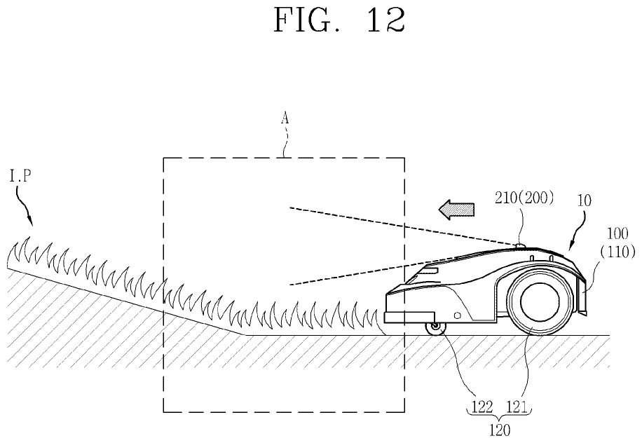

FIG. 12 is a lateral view illustrating that the lawn mower robot 10 moves on the ground. In the illustrated embodiment, there is an incline part on the ground spaced apart from the lawn mower robot 10 by a predetermined distance. An area where one side surface of the incline part facing the lawn mower robot 10 and a horizontal ground surface meet may be defined as an area A.

The image sensor module 210 detects image information related to the area A. In addition, the position sensor module 230 detects position information that the incline part is present in the area A and the lawn mower robot 10 is approaching the area A.

The image information detected by the image sensor module 210 and the position information detected by the position sensor module 230 are transmitted to the detection information reception module 340. The transmitted image information and position information are then transmitted to the image information calculation unit 351 and the position information calculation unit 352, respectively.

The image information calculation unit 351 calculates the incline part information through the aforementioned processes using the transferred image information. The calculated incline part information is transmitted to the inclination information calculation unit 355.

The position information calculation unit 352 calculates the incline part information through the aforementioned processes using the transferred position information. The calculated incline part information is transmitted to the inclination information calculation unit 355.

The inclination information calculation unit 355 then calculates inclination information using the transmitted incline part information. The inclination information is transmitted to the operation information calculation module 320 along with each incline part information.

The operation information calculation module 320 calculates operation information by using at least one of the calculated incline part information and inclination information. The operation information may be calculated for the lawn mower robot 10 to enter the incline part and perform a task on the incline part. Alternatively, the operation information may be calculated for the lawn mower robot 10 to avoid the incline part.

The operation information calculated by the operation information calculation module 320 may be transferred to the operation control module 330 so that the power module 130 can operate according to the calculated operation information.

Hereinafter, the embodiment illustrated in FIGS. 13 to 16 will be described under assumption that operation information calculated by the operation information calculation module 320 is operation information for the lawn mower robot 10 to enter the incline part and perform a task. Description will also be given under assumption that the ground other than an incline part is horizontal.

Referring to FIG. 13, a situation in which the lawn mower robot 10 is continuously traveling and enters the area A is illustrated. The illustrated embodiment will be understood as one embodiment of a process of calculating incline part information and inclination information using image information detected by the image sensor module 210.

Through the process, the image sensor module 210 detects the image information. The image information calculation unit 351 calculates incline part information using the detected image information.

The process in which the image information calculation unit 351 compares the calculated incline part information with reference incline part information and determines whether or not there is the incline part according to the comparison result is as described above.

Therefore, another embodiment in which the image information calculation unit 351 calculates incline part information will be described hereinafter.

In the illustrated embodiment, the image information calculation unit 351 calculates detected image information as totally three boundaries. That is, the three boundaries include a surface line S.L shown along one side surface of the incline part, a grass line G.L shown along an upper boundary of the grass, and a reference line R.L for determining whether an inclination exists.

The reference line R.L may be set to a maximum height of the grass line G.L when no incline part is present. Alternatively, the reference line R.L may be set to a maximum height of the surface line S.L when no incline part is present.

In the illustrated embodiment, the reference line R.L is set to the maximum height of the grass line G.L. In the image information detected by the image sensor module 210, the grass line G.L is shown to be higher than the reference line R.L.

Therefore, the image information calculation unit 351 may calculate incline part information indicating that an incline part exists in a direction in which the lawn mower robot 10 travels. The calculated incline part information is transferred to the inclination information calculation unit 355.

The inclination information calculation unit 355 calculates inclination information using the transmitted incline part information. The calculated inclination information is transmitted to the operation information calculation module 320 along with the incline part information.

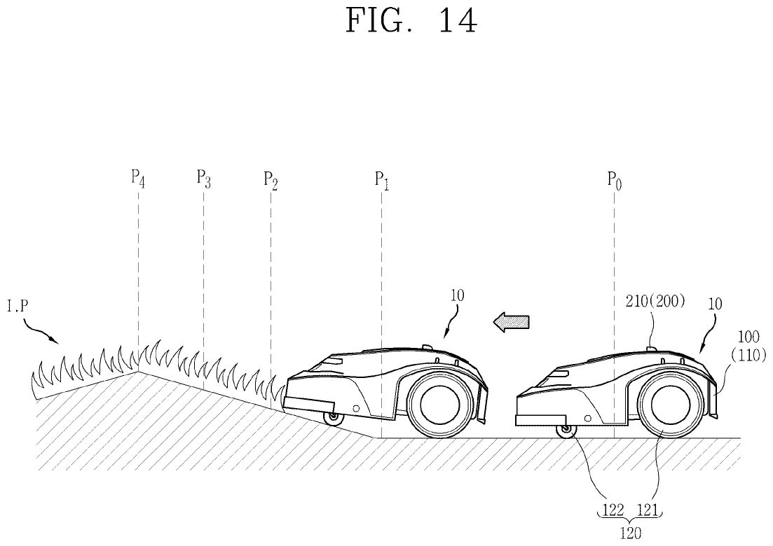

Referring to FIG. 14, a situation in which the lawn mower robot 10 is continuously traveling and enters the area A is illustrated. The illustrated embodiment will be understood as one embodiment of a process of calculating incline part information and inclination information using position information detected by the position sensor module 230.

Through the process, the position sensor module 230 detects the position information. The position information calculation unit 352 calculates the incline part information using the detected position information.

The process of calculating a difference between the incline part information calculated by the position information calculation unit 352 and the reference incline part information, that is, a difference between the respective pieces of information calculated in the form of distance information has been described above.

Therefore, another embodiment in which the position information calculation unit 352 calculates incline part information will be described hereinafter.

In the illustrated embodiment, the position information calculation unit 352 divides a preset area in which the lawn mower robot 10 is performing a task into a total of five points.

That is, the five points includes a flat point P0, a point (hereinafter, referred to as the “joint point”) P1 where one side surface of the incline part facing the lawn mower robot 10 joints the flat ground, a first inclined point P2, a second inclined point P3, and a top point P4. The position information related to each point P0, P1, P2, P3, and P4 may be transmitted from the position information storage unit 433.

The position sensor module 230 detects that the lawn mower robot 10 is moving from the flat point P0 to the joint point P1. When the lawn mower robot 10 reaches the joint point P1, the position sensor module 230 detects position information related to the point. The detected position information is transmitted to the position information calculation unit 352 via the position information reception unit 343.

The position information calculation unit 352 calculates incline part information using the transmitted position information and the position information related to each point P0, P1, P2, P3, and P4.

The incline part information calculated by the position information calculation unit 352 is transmitted to the inclination information calculation unit 355. The inclination information calculation unit 355 calculates extension distance information from the joint point P1 to the top point P4, angle information between the incline part (inclined surface) extending from the joint point P1 to the top point P4 and the ground, and the like.

In addition, the inclination information calculation unit 355 may calculate extension distance information and angle information between the joint point P1 and the first inclined point P2, between the first inclined point P2 and the second inclined point P3, and between the second inclined point P3 and the top point P4, respectively.

The calculated inclination information and incline part information are transmitted to the operation information calculation module 320.

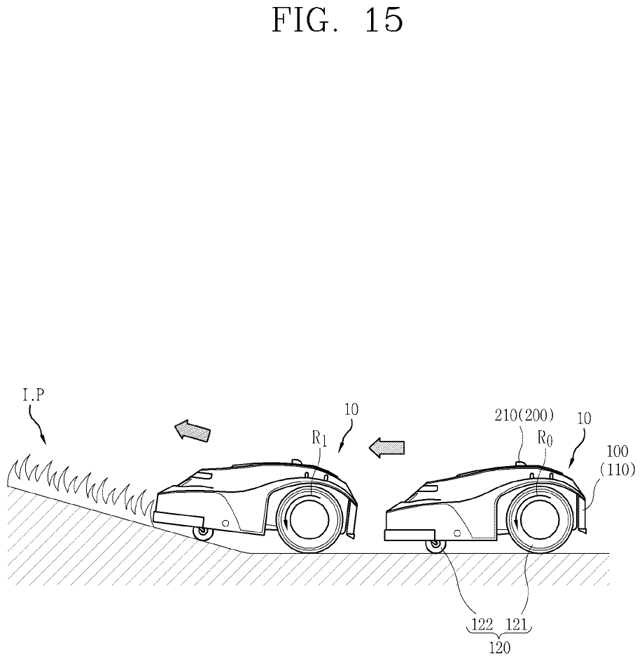

Referring to FIG. 15, a situation in which the lawn mower robot 10 has continuously traveled so as to enter the area A is illustrated. The illustrated embodiment will be understood as one embodiment of a process of calculating incline part information and inclination information using rotation information detected by the rotation sensor module 240.

Through the process, the rotation sensor module 240 detects the rotation information. The rotation information may include first rotation information related to the first main wheel 121a and second rotation information related to the second main wheel 121b.

The rotation information calculation unit 353 calculates incline part information using the detected rotation information. The process of calculating a difference between the incline part information calculated by the rotation information calculation unit 353 and the reference incline part information, that is, a difference between the respective pieces of information calculated in the form of time information has been described above.

Therefore, another embodiment in which the rotation information calculation unit 353 calculates incline part information will be described hereinafter.

The rotation sensor module 240 detects initial rotation information R0 which is rotation information on the flat ground. The initial rotation information R0 includes first rotation information and second rotation information.

In addition, after the lawn mower robot 10 enters the incline part, the rotation sensor module 240 detects late rotation information R1 which is rotation information after entering the incline part. The late rotation information R1 also includes the first rotation information and the second rotation information.

Assuming that the power module 130 is rotating at the same speed, the late rotation information R1 may have a lower value than the initial rotation information R0.

Accordingly, the rotation information calculation unit 353 calculates the incline part information as the value of the late rotation information R1 is reduced to be smaller than the value of the initial rotation information R0. The calculated incline part information is transferred to the inclination information calculation unit 355.

The inclination information calculation unit 355 calculates inclination information using the transmitted incline part information. The calculated inclination information is transmitted to the operation information calculation module 320 along with the incline part information.

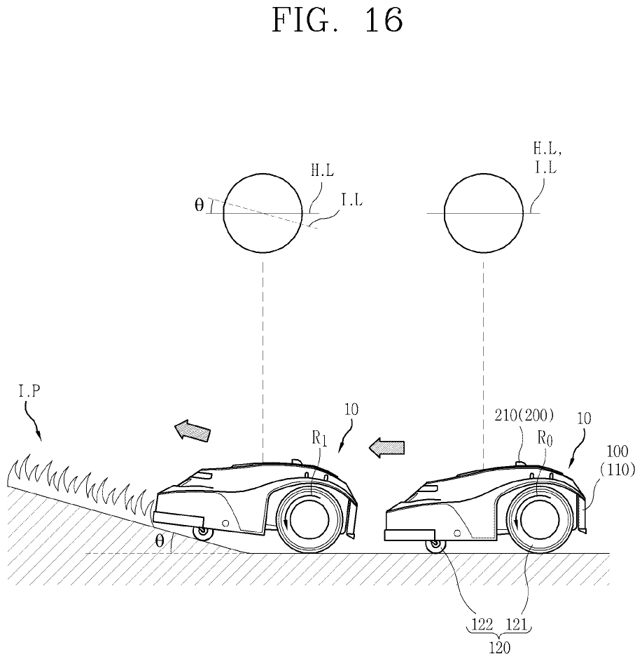

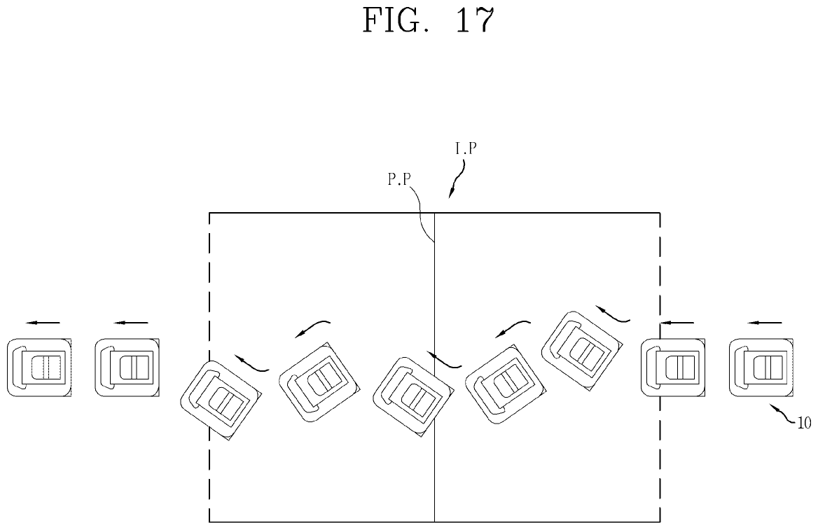

Referring to FIG. 16, a situation in which the lawn mower robot 10 has continuously traveled so as to enter the area A is illustrated. The illustrated embodiment will be understood as one embodiment of a process of calculating incline part information and inclination information using tilt information detected by the tilt sensor module 250.

Through the process, the tilt sensor module 250 detects the tilt information. Also, the tilt information calculation unit 354 calculates incline part information using the detected tilt information. The process of comparing the incline part information calculated by the tilt information calculation unit 354 and the reference incline part information, namely, the process of comparing the incline part information calculated in the form of angle information and the reference incline part information has been described above.

Therefore, another embodiment in which the tilt information calculation unit 354 calculates incline part information will be described hereinafter.

The detected tilt information may be represented by a horizontal line H.L and an inclined line I.L. The horizontal line H.L refers to a tilt of the ground. In addition, the inclined line I.L refers to a tilt of the lawn mower robot 10.

When the lawn mower robot 10 is traveling on a flat surface, the inclined line I.L is horizontal. That is, the inclined line I.L coincides with the horizontal line H.L.

When the lawn mower robot 10 continues to travel to enter the area A, the lawn mower robot 10 is inclined as much as the incline part being tilted. Therefore, the inclined line I.L forms a predetermined angle θ with the horizontal line H.L.

The tilt information detected by the tilt sensor module 250 includes the above contents. The tilt information calculation unit 354 calculates incline part information using the tilt information. The calculated tilt information is transmitted to the inclination information calculation unit 355.

The inclination information calculation unit 355 calculates inclination information using the transmitted incline part information. The calculated inclination information is transmitted to the operation information calculation module 320 along with the incline part information.

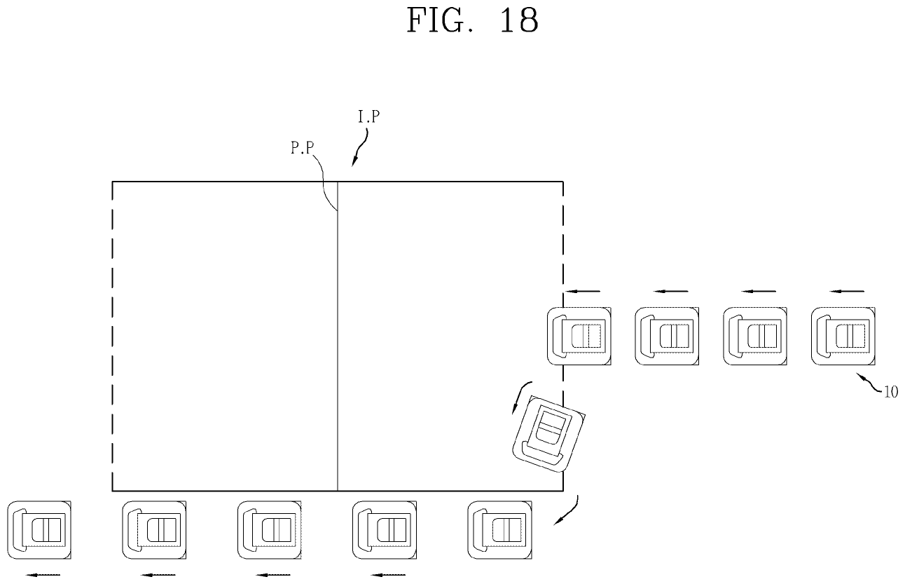

Referring to FIG. 17, a process of operating the lawn mower robot 10 by the operation information calculated through the process is illustrated. The illustrated embodiment corresponds to a case where operation information for the lawn mower robot 10 to perform a task on an incline part is calculated.

The lawn mower robot 10 enters an incline part I.P and proceeds along one side surface of the inclined portion, that is, one side surface facing the lawn mower robot 10. At this time, the lawn mower robot 10 alternately moves toward the left and right so as to proceed toward a top point of the incline part I.P.

This is to effectively perform a task even on the surface of the incline part I.P, as described above. In addition, as the lawn mower robot 10 travels zigzag, power required for the travel of the lawn mower robot 10 may be reduced.

The lawn mower robot 10 that has passed through the top point is traveling along another side surface of the incline part, which is opposite to the one side surface of the incline part. At this time, the lawn mower robot 10 alternately moves toward the left and right so as to pass through the incline part I.P. That is, the lawn mower robot 10 travels zigzag along the another side surface of the incline part I.P.

Referring to FIG. 18, a process of operating the lawn mower robot 10 by the operation information calculated through the process is illustrated. The illustrated embodiment corresponds to a case where operation information for the lawn mower robot 10 to avoid the incline part I.P is calculated.

After the lawn mower robot 10 passes through a portion where the incline part I.P is in contact with the ground, the lawn mower robot 10 is traveling to the left or right. In the illustrated embodiment, the lawn mower robot 10 proceeds by rotating to the left.

Alternatively, the process may be performed before the lawn mower robot 10 reaches the portion where the incline part I.P and the ground are in contact with each other.

When the lawn mower robot 10 completely exits the incline part I.P, the lawn mower robot 10 is traveling straight along one side surface of the incline part I.P. The traveling direction of the lawn mower robot 10 may change according to a pre-input control signal.

The embodiment may be preferable when the lawn mower robot 10 needs excessive power to proceed to the incline part I.P. In addition, it may be preferable even in the case where the lawn mower robot 10 is not suitable to proceed due to a narrow width of the incline part I.P.

As described above, a lawn mower robot 10 according to an embodiment of the present disclosure and a control method thereof can effectively detect an incline part (inclined portion) located on a travel path. Accordingly, operation information for the lawn mower robot 10 to pass or avoid the incline part, rather than operation information for the lawn mower robot 10 to travel on a flat surface, can be calculated.

That is, the lawn mower robot 10 can travel to pass through the incline part or travel to avoid the incline part. The traveling is performed according to operation information calculated based on incline part information and inclination information. Accordingly, even if the lawn mower robot 10 is traveling to pass through the incline part, slippage of the main wheel 121 can be prevented.

Therefore, the lawn mower robot 10 can travel according to operation information suitable for a travel environment. This may result in improving efficiency of a lawn-mowing task, and thus enhancing user's satisfaction.

The foregoing description has been given of the preferred embodiments, but it will be apparent to those skilled in the art that various modifications and variations can be made in the present disclosure without departing from the scope of the disclosure as defined in the appended claims.

What is claimed is:

1. A lawn mower robot comprising:
a body part to which a main wheel is rotatably coupled;
a power module connected to the main wheel and rotated according to operation information so as to rotate the main wheel;
a sensor part provided on the body part to detect external image information on one side of the body part; and
a controller configured to calculate the operation information, the controller electrically connected to the power module to transfer the calculated operation information, and electrically connected to the sensor part to receive the detected image information,
wherein the controller calculates the operation information using the detected image information.

2. The lawn mower robot of claim 1, wherein the controller calculates incline part information related to whether or not an incline part is present on a ground of the one side, using the detected image information.

3. The lawn mower robot of claim 2, wherein,
the controller calculates inclination information related to the incline part using the detected image information, and
the inclination information comprises:
angle information related an angle between a surface of the incline part and the ground; and
extension distance information related to a distance by which the surface of the incline part extends.

4. The lawn mower robot of claim 3, wherein the controller calculates the operation information using the calculated incline part information and inclination information.

5. The lawn mower robot of claim 4, wherein the main wheel comprises:
a first main wheel located on one side of the body part; and
a second main wheel located on another side of the body part, opposite to the first main wheel,
the power module comprises;
a first power module connected to the first main wheel; and
a second power module connected to the second main wheel, and the operation information comprises:
first steering information for controlling a rotational speed of the first power module; and
second steering information for controlling a rotational speed of the second power module.

6. The lawn mower robot of claim 5, wherein the controller calculates the first steering information and the second steering information, so that the rotational speed of the first power module and the rotational speed of the second power module alternately change in magnitude.

7. The lawn mower robot of claim 3, wherein,
the sensor part is configured to detect tilt information related to an angle between the body part and the ground, and
the controller calculates the incline part information and the inclination information using the detected tilt information.

8. The lawn mower robot of claim 3, wherein,
the sensor part is configured to detect rotation information related to turns of the main wheel, and
the controller calculates the incline part information and the inclination information using the detected rotation information.

9. The lawn mower robot of claim 3, wherein,
the sensor part is configured to detect position information related to a position of the body part, and
the controller calculates the incline part information and the inclination information using the detected position information.

10. A method for controlling a lawn mower robot, the method comprising:
(a) detecting, by a sensor part, information related to an operating state of the lawn mower robot;
(b) calculating, by an incline part information calculation module, information related to an external environment of the lawn mower robot using the detected information;
(c) calculating, by an operation information calculation module, operation information using the calculated information related to the external environment; and
(d) controlling a power module according to the calculated operation information.

11. The method of claim 10, wherein the step (a) comprises:
(a1) sensing, by an image sensor module, external image information related to one side of a body part of the lawn mower robot;
(a2) detecting, by a position sensor module, position information related to a position of the body part;
(a3) sensing, by a rotation sensor module, rotation information related to turns of a main wheel rotatably connected to the body part; and
(a4) detecting, a tilt sensor module, tilt information related to an angle between the body part and a ground.

12. The method of claim 11, wherein the step (b) comprises:
(b1) calculating, by the incline part information calculation module, incline part information related to whether an incline part is present on the ground of the one side by a preset method, using at least one of the detected image information, position information, rotation information, and tilt information;
(b2) comparing, by the incline part information calculation module, the calculated incline part information with preset reference incline part information; and
(b3) calculating, by the incline part information calculation module, inclination information related to inclination of the incline part by a preset method using at least one of the detected image information, position information, rotation information, and tilt information, when a result of the comparison corresponds to a preset condition, and
the preset condition corresponds to presence of the incline part on the ground of the one side.

13. The method of claim 12, wherein the step (c) comprises:
(c1) calculating, by a driving information calculation unit, driving information by a preset method using at least one of the calculated incline part information and inclination information; and
(c2) calculating, by a steering information calculation unit, steering information by a preset method using at least one of the calculated incline part information and inclination information.

14. The method of claim 13, wherein the main wheel comprises:
a first main wheel located on one side of the body part; and
a second main wheel located on another side of the body part, opposite to the first main wheel,
the power module comprises:
a first power module connected to the first main wheel; and
a second power module connected to the second main wheel, and
the steering information calculated in the step (c1) is calculated so that a rotational speed of the first power module and a rotational speed of the second power module alternately change in magnitude.

15. The method of claim 13, wherein the step (d) comprises:
(d1) rotating, by a power module control unit, the power module according to the calculated steering information; and
(d2) rotating, by the power module control unit, the power module according to the calculated driving information.

16. The method of claim 15, further comprising after the step (d):
(e) operating the power module according to preset operation information.

17. The method of claim 16, wherein the step (e) comprises:
(e1) detecting, by the image sensor module, the external image information related to the one side of the body part of the lawn mower robot;
(e2) calculating, by the incline part information calculation module, the incline part information by a preset method using the detected image information;
(e3) comparing, by the incline part information calculation module, the incline part information with reference incline part information; and
(e4) controlling, by the power module control unit, the power module according to preset operation information when a result of the comparison does not correspond to the preset condition.

18. The method of claim 17, wherein the step (e) comprises after the step (e3):
(e5) calculating, by the incline part information calculation module, inclination information using the image information detected by the incline part information calculation module, when the result of the comparison corresponds to the preset condition;
(e6) calculating, by the driving information calculation unit, driving information by using at least one of the calculated incline part information and inclination information;
(e7) calculating, by the steering information calculation unit, steering information using at least one of the detected incline part information and inclination information; and
(e8) controlling, by the power module control unit, the power module according to the calculated driving information and steering information.
